(19) United States
(12) Patent Application Publication
(10) Pub. No.: US 2024/0358005 A1
(43) Pub. Date: Oct. 31, 2024

(54) SYSTEM AND METHOD FOR FISH PUMP LOADING AND CURRENT ZONE CREATION

(71) Applicant: East Coast Innovation Inc., Saint Andrews (CA)

(72) Inventors: Joel Benjamin HALSE, Saint Andrews (CA); David Werner FALKJAR, Upper Letang (CA); Max David FALKJAR, Saint John (CA); Jonathan Geoffrey HALSE, Saint Andrews (CA)

(21) Appl. No.: 18/577,302

(22) PCT Filed: Jul. 11, 2022
(86) PCT No.: PCT/CA2022/000030

§ 371 Date: Jan. 8, 2024

Related U.S. Application Data
(60) Provisional application No. 63/220,177, filed on Jul. 9, 2021.
(60) Provisional application No. 63/220,166, filed on Jul. 9, 2021.
(60) Provisional application No. 63/278,650, filed on Nov. 12, 2021.

(51) Int. Cl. A01K 63/04; F04F 5/10

(52) U.S. Cl. CPC A01K 63/047; F04F 5/10

(57) ABSTRACT

A fish pump loading system includes a pump suction inlet to receive a first input water stream including a combination of fish and water. At least one water flow generator receives a second input water stream that is independent of the first input water stream. A water flow generator nozzle modifies the second input water stream at an outlet of the water flow generator to produce a modified output water stream and is positioned in proximity to the pump suction inlet such that the first input water stream interacts with and alters the modified output water stream to produce a conversion zone having a first fast-moving conversion current drawing into the pump suction inlet to rapidly convert the fish into the first input water stream after the fish swim into the conversion zone. A pump suction outlet transmits the combination of fish and water to a fish pump entrance.

### CROSS-REFERENCE TO RELATED APPLICATIONS

This application claims priority to U.S. Provisional Patent Application Nos. 63/220,177, filed Jul. 9, 2021, 63/220,166 filed Jul. 9, 2021, and 63/278,450 filed Nov. 12, 2021, all of which are incorporated by reference in their entirety.

### FIELD

The present disclosure relates to transferring or transporting fish, including but not limited to a system and method for fish pump current zone creation.

### BACKGROUND

Industrial fish farming requires the movement of large populations of fish at several different stages in the farming process. This is done using fish pumping systems. These systems move large volumes of water and any fish contained within the water. The fish must be moved to the input of the pump and then be drawn into the pumping system. However, the instinctive response of the fish to the currents and conditions created by the pumping system is to swim against the current and away from the pump.

A known approach is to physically crowd the fish into the volume of water being drawn into the pump and force them into the pumping system as they attempt to swim away. This method of crowding and handling of the fish has many negative effects on fish health, which is made worse by extended periods of stress and their attempt to escape. Conditions worsen as time progresses for the population of fish waiting in crowded conditions, until they are drawn into the pump. Depending on fish population and pumping system capacity, these conditions can last hours, and create a dynamic where pumping operators must balance fish health and number of mortalities against operational requirements to move the population in a limited window of time.

Improvements in approaches for transferring or transporting fish are desirable.

### BRIEF DESCRIPTION OF THE DRAWINGS

Embodiments of the present disclosure will now be described, by way of example only, with reference to the attached Figures.

FIG. 1 illustrates a schematic of an embodiment according to the present disclosure of a fish pump loading system for generating water flow and creating a conversion zone.

FIG. 2 illustrates an embodiment of a fish pump loading system according to the present disclosure for use in a fish cage or tank and in use with a fish pump.

FIG. 3 illustrates a perspective view of an embodiment of a fish pump loading system according to the present disclosure.

FIG. 4 illustrates a perspective view of an embodiment of a fish pump loading system in use, according to the present disclosure, where arrows indicate the direction of fish movement.

FIG. 5 illustrates an embodiment according to the present disclosure of a fish pump loading system for generating water flow and creating a conversion zone.

FIG. 6 illustrates an embodiment of a fish pump loading system according to the present disclosure for use in a fish cage or tank and in use with a fish pump.

FIG. 7 illustrates an example of a known approach to drawing fish into a fish pump using a suction bell.

FIG. 8 illustrates a side or top view of an embodiment of fish pump loading system according to the present disclosure for generating water flow and creating an attraction zone and a conversion zone, where a water flow generator is adjacent (beside, above, or below) the pump suction.

FIG. 9 illustrates an embodiment of a fish pump loading system according to the present disclosure for generating water flow and creating an attraction zone and a conversion zone, including a water flow generator in line with (behind) the pump suction to create a cross-flow.

FIG. 10 illustrates a side or top view of an embodiment of a fish pump loading system for generating water flow and creating an attraction zone and a conversion zone, where a water flow generator is separated (behind or beside) with respect to the pump suction.

FIG. 11 is a side or top view of an embodiment of a fish pump loading system according to the present disclosure for generating water flow and creating an attraction zone and a conversion zone, where the pump suction is between or adjacent to at least two water flow generators.

FIG. 12 illustrates a side view of an embodiment of a fish pump loading system according to the present disclosure for generating water flow and creating an attraction zone and a conversion zone, where the system includes a physical dam structure between the attraction zone and the conversion zone.

FIG. 13 illustrates a perspective view of an embodiment of a fish pump loading system according to the present disclosure.

FIG. 14 illustrates a side view, partially in cross-section, of an embodiment of a fish pump loading system according to the present disclosure, coupled to a tank.

FIG. 15 illustrates a perspective view of an embodiment of a fish pump loading system in use, according to the present disclosure, where arrows indicate the direction of water flow.

FIG. 16 illustrates a side view of the fish pump loading system of FIG. 13 and FIG. 15.

FIG. 17 illustrates a perspective view of an embodiment of a fish pump loading system according to the present disclosure in use as a drop-in sea site unit.

FIG. 18 illustrates an example of water flow circulation for an embodiment of a fish pump loading system according to the present disclosure.

FIG. 19 illustrates a sea cage illustrating the guidance of fish towards an embodiment of a fish pump loading system according to the present disclosure.

FIG. 20 illustrates the incorporation of an embodiment of a fish pump loading system according to the present disclosure into an existing fish pump system.

FIG. 21 illustrates the flow of water for an embodiment of a fish pump loading system according to the present disclosure.

FIG. 22 illustrates a water management system for use with a fish pump loading system according to one or more embodiments of the present disclosure.

FIG. 23 illustrates a fish guidance system for use with a fish pump loading system according to one or more embodiments of the present disclosure.

FIG. 24 illustrates a top view of a plurality of sea cages for fish, each integrating an embodiment of a fish pump loading system.

### DETAILED DESCRIPTION

A fish pump loading system includes a pump suction inlet to receive a first input water stream including a combination of fish and water. A water flow generator receives a second input water stream, and includes a water flow generator nozzle to produce a modified output water stream. The water flow generator is positioned in proximity to the pump suction inlet such that the first input water stream interacts with and alters the modified output water stream to produce: an attraction zone, having a first attraction current, to draw upstream-swimming fish towards the pump suction inlet; and a conversion zone adjacent the attraction zone and having a second fast-moving conversion current drawing into the pump suction inlet to rapidly convert the fish into the first input water stream after the fish swim into the conversion zone. A pump suction outlet transmits the combination of fish and water to a fish pump entrance.

In another aspect, a fish pump loading system includes a fish loading apparatus having a fish loading inlet and a fish outlet and a water flow generator having a water inlet and a flow generator outlet. A fish loading flow path communicates with the fish loading inlet and the fish outlet to receive a first input water stream including a combination of fish and water and to transmit the combination of fish and water to a fish pump entrance. A water modification flow path communicates with the water inlet and the flow generator outlet to receive a second input water stream and to produce a modified output water stream. The water modification flow path interacts with the fish loading flow path to produce a modified output water stream. The water modification flow path interacts with the fish loading flow path to produce an attraction zone to draw upstream-swimming fish towards the fish pump entrance, the attraction zone has a first attraction current; and a conversion zone adjacent the attraction zone and having a second fast-moving conversion current drawing into the fish pump entrance to rapidly convert the fish into the fish pump entrance after the fish swim into the conversion zone.

In another aspect, a fish pump loading system includes a pump suction inlet to receive a first input water stream including a combination of fish and water. At least one water flow generator receives a second input water stream that is independent of the first input water stream. A water flow generator nozzle modifies the second input water stream at an outlet of the water flow generator to produce a modified output water stream and is positioned in proximity to the pump suction inlet such that the first input water stream interacts with and alters the modified output water stream to produce a conversion zone having a first fast-moving conversion current drawing into the pump suction inlet to rapidly convert the fish into the first input water stream after the fish swim into the conversion zone. A pump suction outlet transmits the combination of fish and water to a fish pump entrance.

In another aspect, a fish pump loading system includes a fish loading apparatus having a fish loading inlet and a fish outlet and a water flow generator having a water inlet and a flow generator outlet. A fish loading flow path communicates with the fish loading inlet and the fish outlet to receive a first input water stream including a combination of fish and water and to transmit the combination of fish and water to a fish pump entrance. A water modification flow path communicates with the water inlet and the flow generator outlet to receive a second input water stream independent of the first input water stream and to produce a modified output water stream. The water modification flow path interacts with the fish loading flow path to produce a conversion zone having a first fast-moving conversion current drawing into the fish pump entrance to rapidly convert the fish into the fish pump entrance after the fish swim into the conversion zone; and a loading zone adjacent the conversion zone having a second slower moving current, to draw upstream-swimming fish towards the conversion zone.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Embodiments of the present disclosure use currents and complex geometries to create conditions leading up to, and at the entry to, a fish pump or fish pumping system that change the dynamic such that the instinctive behaviour of the fish is to swim into the loading region of the pump. At the loading region of the pump, according to embodiments described herein, the fish are rapidly and safely drawn into the pumping system without the negative effects of physical handling or extended periods of high stress. The balance of the population is maintained in healthy, low stress conditions. This change in dynamic allows the operator to maximize the fish pump transfer rate without compromising fish health and improves the overall efficiency of the pumping process by removing the need to compromise fish transfer rate to mitigate damage to the fish population health.

The global salmon farming industry is currently using an inefficient process to handle the movement of fish, from one location to another; between net pens or tanks or from farm to vessel. The current approach is to corral large volumes of fish, significantly increasing biomass density of the entire population as they are loaded into a fish pump. This increased density can negatively impact the fish by causing them to lose the ability to swim and decreases oxygen levels which results in multiple physiological responses to the stress. Such a known process is labour intensive, requires constant management of population density, and inconsistent biomass density decreases operational efficiency. Negative health consequences to fish leads to immediate mortalities and refusal to feed and delayed consequences such as increased vulnerability to disease and/or parasites, causing the operator to experience reduced yields and increased costs.

To move large populations of fish on an industrial level requires a fish pump. A fish pump moves water, such that moving a given biomass of fish requires a specific range of density of biomass per volume of water. During most of their lifecycle, salmon and other farmed species naturally swim against the current. When presented with a fish pump drawing current towards the pump entry, the fish will actively swim away from the pump entrance.

Known approaches to solving this problem physically corral a population of fish into a small volume of water at the inlet of the pump. Trying to bring together a large mass of fish and draw them into a fish pump has many negative impacts on fish health, including: crowding effects—fish at the bottom of the population are under pressure from those above, trying to escape downward; inability to swim; low oxygen; physiological stress response—lactic acid in muscles, increasing oxygen demand and consumption.

The impact of these problems are significant. It is labour intensive to coral the fish, requiring constant management of the population density at the fish pump intake. Inconsistent biomass density at the pump intake leads to negative impact on operational efficiency. Fish health consequences include: live fish operations—can result in immediate mortalities and delayed consequences such as increased vulnerability to disease or parasites; fish harvesting operations—can result in mortalities prior to the fish arriving at processing making the fish inviable for human consumption. Stressful handling also negatively impacts the meat quality of the harvested fish.

Embodiments of the present disclosure provide fish pump loading systems which overcome one or more of the aforementioned problems. The fish pump loading system may be referred to as a Voluntary Swim-In (VSI) apparatus or a Pump Input Unit. The system improves fish transfer, by reducing or eliminating the need for fish crowding and forcing them to move against their natural instincts. Instead, according to embodiments of the present disclosure, through the generation of currents, water flow patterns and controlling other variables, conditions are created under which fish swim naturally and voluntarily up to the fish loading system, where they are rapidly and safely transitioned or converted into the fish pump.

Current systems require taking fish off feed before they are moved, and the fish do not return to normal feeding behaviour for a period of time after transfer due to the stress of the existing process. This results in significant loss of feed time and consequent loss of growth. One advantage of the system according to embodiments of the present disclosure is that it does not disrupt the normal feeding behaviour of the fish.

A problem with current approaches is that the fish fight against the system being used to move them; fish don't want to go where they are being forced to go. The system according to embodiments of the present disclosure switches that dynamic and creates conditions where the fish voluntarily swim up to the pump input where they are rapidly and safely drawn into the pump. The bulk of the waiting population of fish are maintained at a healthy biomass density, removing the stressful conditions that lead to loss of appetite. Fish transferred through the system according to embodiments of the present disclosure do not experience extended periods of stress or the resulting loss of appetite, and can return to normal feeding behaviour immediately after transfer.

Many studies have shown that fish have a qualitative experience of the world, have a good ability to learn and remember, have anticipations of the future, have a sense of time, can associate time and place, can make mental maps of their surroundings, can know their group members and can cooperate with them. Fish can also learn by observing others, and some fish can even make innovations and use tools. Most animal welfare scientists and laypeople agree that animal welfare relates to what the individual animals experience and perceive. Animal welfare can be defined as the quality of life as perceived by the animal itself. Fish must have the freedom to control their bodily movements, the ability to move away from danger and also have buoyancy control.

The ability to move away from danger is a fundamental need for all animals, and also to learn to predict danger and learn from aversive incidents. This can be seen in wild fish that panic when they get entangled in fish nets or that can struggle and fight to get loose from a fishing hook. In fish farming, this is also seen when fish are crowded and handled; we can see avoidance behaviour, increased oxygen consumption, catecholamine, cortisol and serotonin levels, all indicating stress and potential fear. Management practices and the exposure to stressors such as repeated disturbance can have a profound impact upon appetite. As a result, the time it takes for appetite to return after e.g. handling, can also be used as an OWI (Operational Welfare Indicators) in aquaculture. Fish growth is intrinsically linked to the feeding and nutritional welfare needs of the fish; when these needs are not met, the fish can exhibit poor growth performance.

Embodiments of the present disclosure create fish movement into a pump, where fish move through the pump in the same direction as water flow. The system may protect the fish from harm, such that fish exiting the fish pump loading system are not slaughtered. The fish can survive the process with no negative impact to fish health. The fish pump loading system can be used in open water pens and self-regulate water levels and flow in a dynamic open water environment. The system can be partially or fully immersed in the water with the population of fish to be loaded into the fish pump. The fish pump loading system apparatus may use a water flow generator, such as a diffuser or a concentrator, and pump intake to create multidirectional currents, resulting in attraction and conversion zones which draw fish into a fish pump.

Some examples of known systems and apparatus for fish movement are as follows, with contrasts to embodiments of the present disclosure. U.S. Pat. No. 7,575,507, discloses a fish stunning apparatus, or a fish processing table, which pumps water through jets on the face of a weir into a reservoir holding a population of fish waiting to be processed. Therein, a water pumping system is positioned such that the output of the pump drives water through the apparatus, creating a current that induces the fish to swim toward the pump. Such an apparatus creates flow of current in a single direction from the pump output; the apparatus is not a fish pump. U.S. Pat. No. 4,437,431 uses current to guide downstream migrating fish into an artificial stream bypassing a hydroelectric dam. Downstream migrating fish are at a point in their lifecycle such that they naturally swim with a current, and accordingly, the apparatus disclosed therein creates a flow of current in a single direction.

WO 2013108251 discloses a system that forces up-current moving fish to go down-current, using water currents and space reduction to force fish to move into a conduit, in opposition to their instinctive movement. The apparatus in WO 2013108251 requires a closed system with control over water volume to function, and cannot be used to load fish into a fish pump in an open cage or open tank environment. U.S. Pat. No. 5,071,314 discloses a fish pump loading apparatus for pumping a catch of fish from a cod end onto a fishing vessel, which is analogous to the aforementioned standard industry approach. The apparatus therein does not create water movement, but instead uses the movement of a net through the water behind a fishing vessel to force fish into the intake of the fish pump; it cannot be used in a fish cage or tank system.

In contrast to such known approaches, the fish pump loading system according to embodiments disclosed herein uses a water flow generator and pump intake to create multidirectional currents, resulting in creation of a conversion zone which draws fish into a fish pump. In other embodiments, the fish pump loading system uses a water flow generator and pump intake to create multidirectional currents, resulting in creation of attraction and conversion zones which draw fish into a fish pump. The fish pump loading system uses an apparatus that can be used in a number of settings, including tank systems and open sea cages, as the system can be integrated to a tank or cage interface, or submerged or suspended in the water. In an embodiment the conversion zone generated by the fish pump loading system may be configured to draw up-current moving fish into a fish pump. In an embodiment the attraction and conversion zones generated by the fish pump loading system may be configured to draw up-current moving fish into a fish pump.

### Biomass Conversion

In some embodiments, biomass loading, such as loading of fish, may occur absent a designated attraction zone. For example, biomass loading may occur by physical placement of a fish pump loading system in a location that makes use of conditions already present during fish handling to load fish.

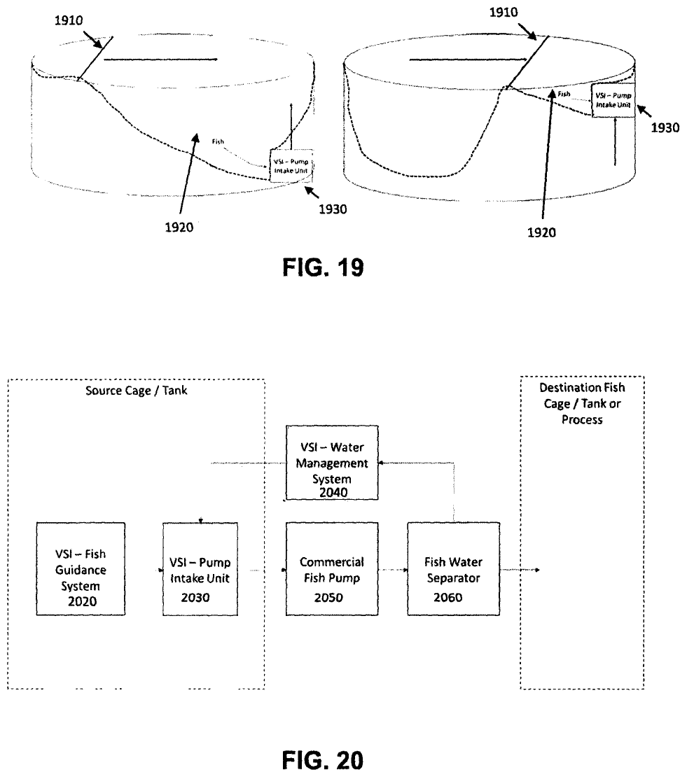

To load biomass, the fish pump loading system may be positioned at the location of highest biomass density, such as the bottom-most region of a sea cage net, such that the location comprises a loading zone. The fish pump loading system may rely on fish guidance, such as corking or seining as illustrated in FIG. 19, rather than attraction of fish.

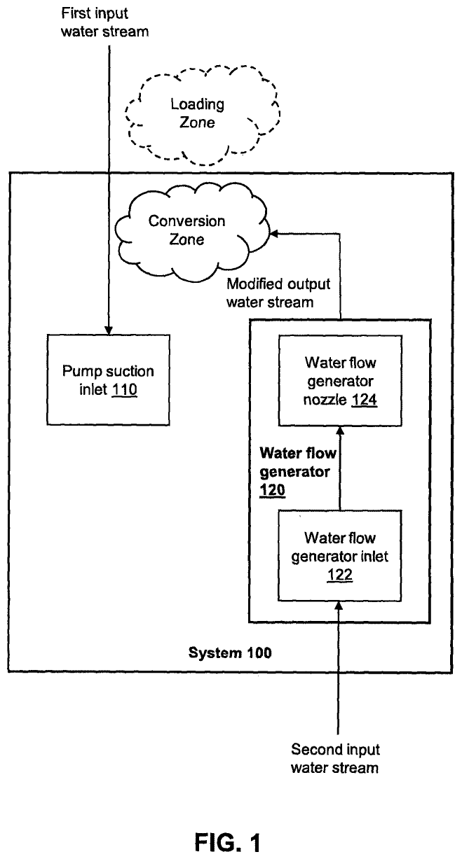

FIG. 1 illustrates a schematic of an embodiment according to the present disclosure of a fish pump loading system for generating water flow and creating a conversion zone. FIG. 1 shows a fish pump system 100 comprising a pump suction inlet 110 configured to receive a first input water stream and a water flow generator 120. The water flow generator may comprise a water flow generator inlet 122 configured to receive a second input water stream and at least one water flow generator nozzle 124 configured to modify the second input water stream at an outlet of the water flow generator to produce a modified output water stream. The water flow generator 120 may be positioned in proximity to the pump suction inlet 110 such that the first input water stream interacts with and alters the modified output water stream to produce a conversion zone. In an embodiment, the system produces the conversion zone adjacent a loading zone. The water flow generator may comprise a water concentrator or a water diffuser.

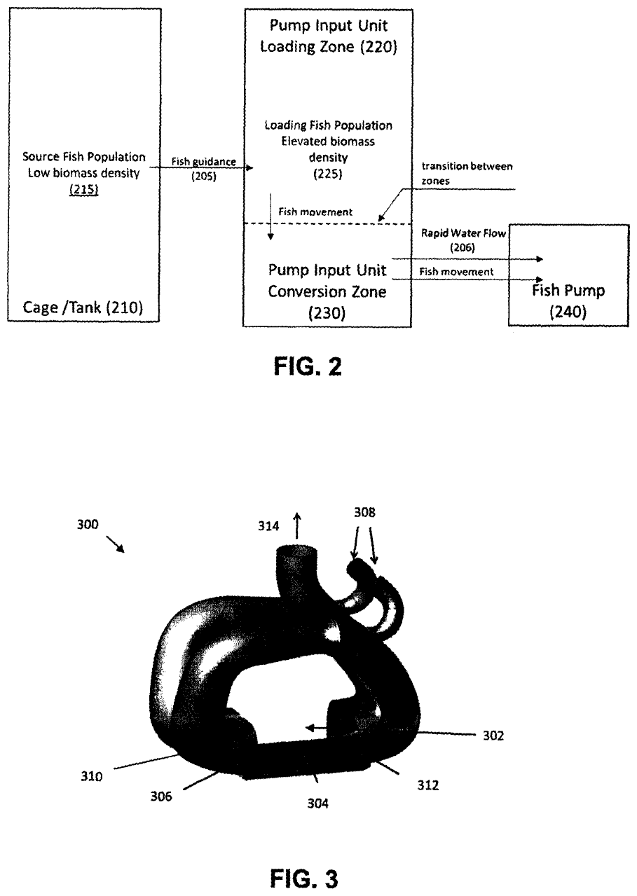

FIG. 2 illustrates an embodiment of a fish pump loading system according to the present disclosure for use in a fish cage or tank and in use with a fish pump. The process flow is shown in FIG. 2, starting with a large fish population 215, for example, contained in a cage, tank, or net 210. The fish pump loading system may use a fish guidance technique 205, such as corking or the use of a seine net, or other physical or non-physical techniques. The fish guidance technique may be any technique suitable to move fish from the source population 215 into the loading zone 220 and bring the population density of the fish population in the loading zone 225 (loading population) up to a target biomass density and maintain it at this density (maintenance density) in the loading zone 220. The maintenance density of the local population is chosen such that it does not threaten the health of the loading fish population 225, but does result in the voluntary movement of fish from the loading population 225 into the conversion zone 230 at a target fish transfer rate.

As shown in FIG. 2, fish guidance by corking or seining, may be performed so as to trigger the fish's natural instinct to swim downward. As a larger proportion of fish swim downward, the loading fish population 225 biomass density rises. The elevated biomass density causes the loading fish population 225 to voluntarily continue to move through this loading zone into the conversion zone 230. According to embodiments of the present disclosure, the system elements are configured so as to create the zones and currents such that the majority of the fish will instinctively swim across a transition line from the loading zone 220 into the conversion zone 230, which may be created by passing a cross-jet through a low point of the loading zone. The conversion zone has a fast moving current 206 into the pump suction, which will rapidly convert the fish into the fish pump 240 once they swim into the conversion zone.

FIG. 3 illustrates an embodiment of a fish pump loading system 300 according to the present disclosure for creating a conversion zone 302. In the example embodiment of FIG. 3, the fish pump loading system 300 may be physically located at a location of desirable biomass density, such as the bottom-most region of a sea cage net. The fish pump loading system 300 may comprise a loading zone 304 accessible to fish so the fish may enter the fish pump loading system 300. A pump suction inlet 312 may be configured to receive a first input water stream from the loading zone 304 which may comprise fish and water. A first fast-moving conversion current 306 may be generated from a water supply (not shown) by at least one water flow generator comprising a water flow generator inlet 308 configured to receive a second input water stream and for generating the first fast-moving conversion current 306 by way of at least one water flow generator nozzle, for example, a cross-jet nozzle 310. The cross-jet nozzle 310 may direct a modified output water stream, for example, a cross-jet (not shown), through the loading zone 304 to rapidly convert fish in the loading zone 304 into the first fast-moving conversion current 306 at pump suction inlet 312 in the conversion zone 302. A fish pump (not shown) may generate suction at the conversion zone 302, which may direct the fish and water through a pump suction outlet 314 away from the fish pump loading system 300 toward a desired location such as toward a fish pump entrance (not shown).

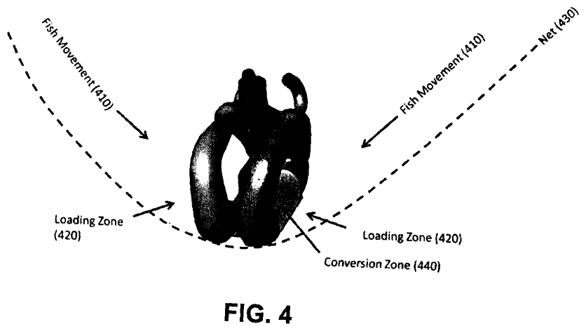

FIG. 4 illustrates a perspective view of an embodiment of a fish pump loading system 300 in use, according to the present disclosure, where arrows indicate the direction of fish movement 410. FIG. 4 illustrates a fish loading flow path flowing through a loading zone 420, the loading zone for example being provided at a point of highest biomass density, such as at the bottom of a net 430. FIG. 4 also illustrates a conversion zone 440 adjacent the loading zone and having a fast-moving conversion current drawing into the fish pump entrance to rapidly convert the fish into the fish pump entrance after the fish swim into the conversion zone.

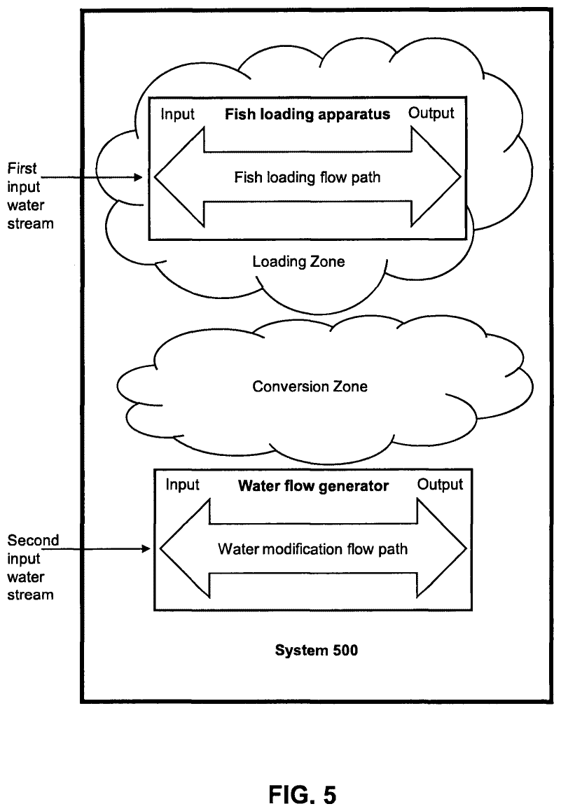

FIG. 5 illustrates an embodiment according to the present disclosure of a fish pump loading system for generating water flow and creating a conversion zone. FIG. 5 shows a fish pump loading system 500 having a fish loading flow path through a fish loading apparatus configured to receive a first input water stream through a fish loading apparatus input in a loading zone. Also shown in FIG. 5 is a water modification flow path through a water flow generator, to create a conversion zone to convert fish in the loading zone. In an example implementation, the fish loading path may be considered to include both the conversion zone and the loading zone.

In an embodiment as shown in FIG. 5, a fish pump loading system 500 includes a fish loading apparatus having a fish loading inlet and a fish outlet and a water flow generator having a water inlet and a flow generator outlet. A fish loading flow path communicates with the fish loading inlet and the fish outlet to receive a first input water stream including a combination of fish and water and to transmit the combination of fish and water to a fish pump entrance. A water modification flow path communicates with the water inlet and the flow generator outlet to receive a second input water stream independent of the first input water stream and to produce a modified output water stream. The water modification flow path interacts with the fish loading flow path to produce a conversion zone having a first fast-moving conversion current drawing into the fish pump entrance to rapidly convert the fish into the fish pump entrance after the fish swim into the conversion zone; and a loading zone adjacent the conversion zone having a second slower moving current, to draw upstream-swimming fish towards the conversion zone.

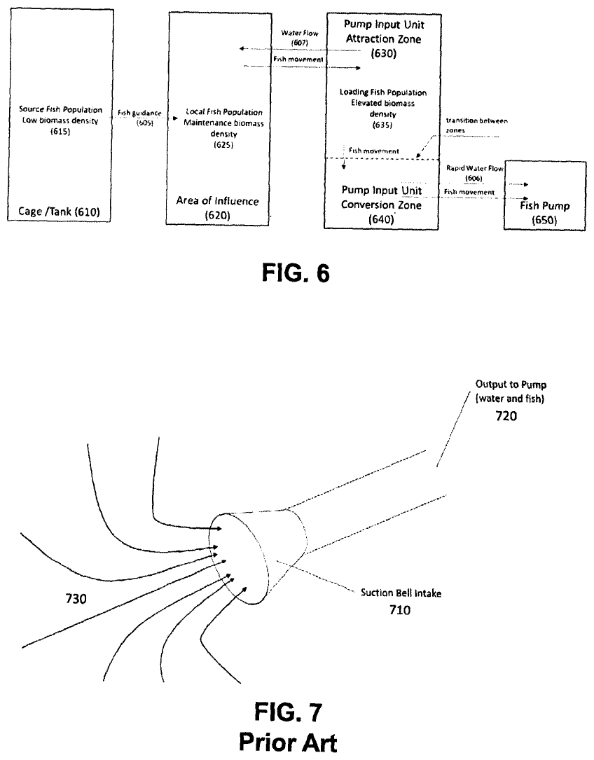

FIG. 6 illustrates an embodiment of a fish pump loading system according to the present disclosure for use in a fish cage or tank and in use with a fish pump. The process flow is shown in FIG. 6, starting with a large fish population 615 in a cage or tank 610. The population is brought into range of the fish pump loading system's Area of Influence 620, for example through use of a fish guidance technique 605. The fish guidance technique may be corking or the use of a seine net. The fish guidance technique may use other physical or non-physical techniques. The fish guidance technique may be any technique suitable to bring the population density of the fish population in the area of influence 625 (local population) up to a target biomass density and maintain it at this density (maintenance density). The maintenance density of the local population 625 is chosen such that it does not threaten the health of the local fish population, but does result in the voluntary movement of fish from the local population 625 into the attraction zone 630 at a target fish transfer rate. As shown in FIG. 6, water flow 607 is provided in an opposite direction of the intended fish movement, so as to attract fish that swim upstream. As the fish follow the attraction current to the attraction zone, the loading fish population 635 biomass density rises. The elevated biomass density causes the loading fish population 635 to voluntarily continue to move through this zone. According to embodiments of the present disclosure, the system elements are configured to as to create the zones and currents such that the majority of the fish will instinctively swim across a transition line from the attraction zone 630 into the conversion zone 640. The conversion zone has a fast moving current 606 into the pump suction which will rapidly convert the fish into the fish pump 650 once they swim into the conversion zone.

Other features may be used to encourage fish to move from the attraction zone into the conversion zone. In one or more embodiments, light may be used as an attractant. For example, the fish pump loading system may further comprise a light source. The fish pump loading system may be coupled to a light source, or a separate light source may be operable with the fish pump loading system. Attractants may include: use of light to attract fish; material selection, colour and surface conditions of the apparatus; geometry and relative position of the apparatus and zones.

FIG. 7 illustrates a known approach to drawing fish into a fish pump using a suction bell 710 as an input to a fish pump 720. This produces a diffuse flow of water 730 towards the suction bell, so any fish swimming against the current is always swimming away from the pump. The fish loading system according to one or more embodiments of the present disclosure may be configured to be adapted for use in conjunction with a suction bell intake, for cooperation with existing fish pumps. The fish loading system according to one or more embodiments herein may be used in place of a suction bell intake, wherein a pump suction concentrator of the fish loading system may operate analogously to a suction bell.

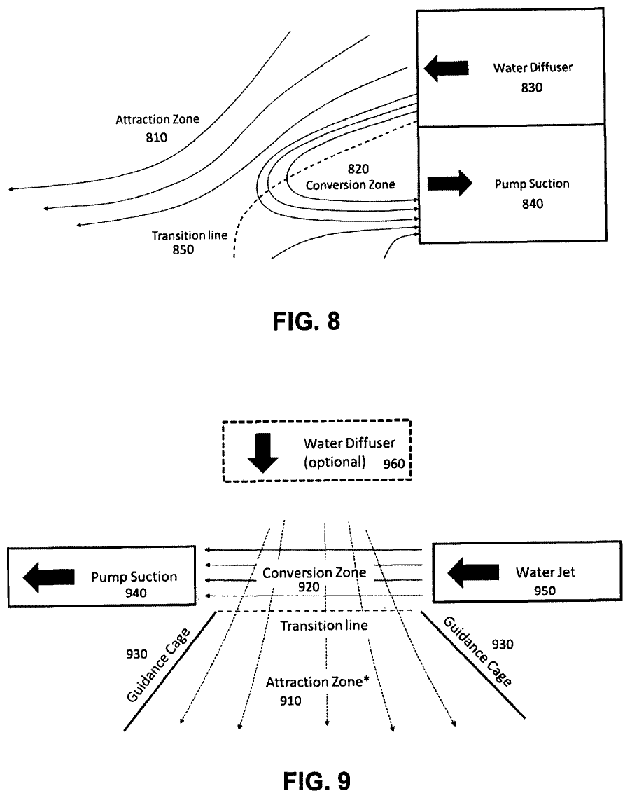

FIG. 8 illustrates a side or top view of an embodiment of fish pump loading system according to the present disclosure for generating water flow and creating an attraction zone 810 and a conversion zone 820, where a water flow generator 830 is adjacent (beside, above, or below) the pump suction 840. FIG. 8 shows an example of one embodiment of the attraction zone 810 and conversion zone 820 through generation of water flow. In an aspect, the present disclosure provides a fish pump loading system comprising a pump suction inlet 840 (shown in FIG. 8 as Pump Suction) configured to receive a first input water stream including a combination of fish and water.

In the embodiment of FIG. 8, the water flow generator may comprise a water diffuser 830 having a water diffuser inlet configured to receive a second input water stream that is independent of the first input water stream, and a water diffuser nozzle configured to diffuse the second input water stream at an outlet of the water diffuser to produce a dispersed output water stream. The water diffuser is positioned in proximity to the pump suction 840 inlet such that the first input water stream interacts with and alters the dispersed output water stream to produce an attraction zone 810 and a conversion zone 820. The attraction zone draws upstream-swimming fish towards the pump suction inlet, and has a first attraction current. The conversion zone is adjacent the attraction zone and has a second fast-moving conversion current drawing into the pump suction inlet to rapidly convert the fish into the first input water stream after the fish swim into the conversion zone. The system also includes a pump suction outlet configured to transmit the combination of fish and water to a fish pump entrance (not shown in FIG. 8).

The embodiment of FIG. 8 can also be described as a fish pump loading system comprising a fish loading apparatus having a fish loading inlet and a fish outlet, and a water diffuser having a water inlet and a diffuser outlet. A fish loading flow path communicates with the fish loading inlet and the fish outlet to receive a first input water stream including a combination of fish and water and to transmit the combination of fish and water to a fish pump entrance. A water diffusion flow path communicates with the water inlet and the diffuser outlet to receive a second input water stream independent of the first input water stream and to produce a dispersed output water stream. The water diffusion flow path interacts with the fish loading flow path to produce: an attraction zone to draw upstream-swimming fish towards the fish pump entrance, the attraction zone having a first attraction current; and a conversion zone adjacent the attraction zone and having a second fast-moving conversion current drawing into the fish pump entrance to rapidly convert the fish into the fish pump entrance after the fish swim into the conversion zone.

The flow pattern illustrated in FIG. 8 may be used, for example, in sea cages. The water diffuser 830 in the apparatus of FIG. 8 is positioned above the pump suction 840 when FIG. 8 is considered a side view. This arrangement is used to create the conversion zone 820 below the attraction zone 810. Alternatively, the diffuser may be positioned beside or below the pump, which would flip or rotate the positions of the zones. For example, when FIG. 8 is considered a top view, the water diffuser and pump suction are side-by-side. The interaction between the water diffuser and pump suction creates the attraction zone and the conversion zone. The transition line 850, indicated in FIG. 8 with a dashed line, is a functional boundary between zones, representing the region where fish move out of attraction current and into the rapid transition current of the conversion zone.

As shown in the embodiment of FIG. 8, the water diffuser 830 may be positioned with respect to the pump suction 840 inlet to create a laminar flow. For example, the laminar flow may include a plurality of tiered water flows. In an example embodiment, the laminar flow includes: a first portion of which wraps tightly back to the pump suction inlet creating the second fast-moving conversion current; and a second portion of which is jetted outwards creating the attraction current.

FIG. 9 illustrates an embodiment of a fish pump loading system according to the present disclosure for generating water flow and creating an attraction zone 910 and a conversion zone 920, including a water flow generator 950 in line with (behind) the pump suction 940 to create a cross-flow. In the example embodiment of FIG. 9, the system implements a cross-flow approach where a rapid flow of current is passed through a diffuse attraction current 910. A fish guidance device 930, for example a fish guidance cage, may be used to direct fish moving along the attraction current to the cross-flow. The conversion zone 920 is created at the intersection of the flows. The water flow generator in this example comprises a flow concentrator configured to create a water jet 950. An optional water diffuser 960, shown at the top of FIG. 9, may be provided to create a diffuse attraction current. For example, a water diffuser may be included if an environmental current does not already exist.

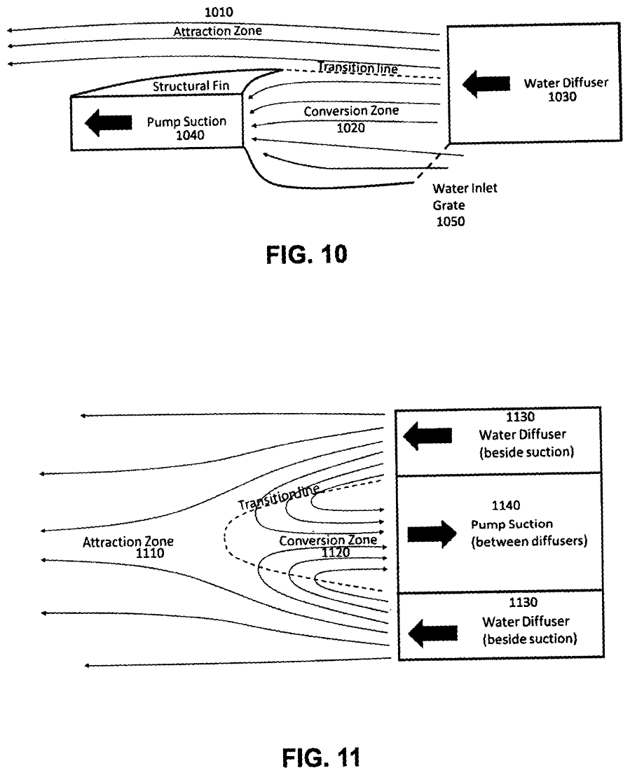

FIG. 10 illustrates a side or top view of an embodiment of a fish pump loading system for generating water flow and creating an attraction zone 1010 and a conversion zone 1020, where a water flow generator is separated 1030 (behind or beside) the pump suction 1040. In particular, FIG. 10 shows another embodiment of a fish pump loading system, in which the pump suction 1040 inlet is placed in front of a water flow generator 1030, which in the example of FIG. 10 may be a water diffuser. In this case, substantially all the water flow occurs in similar directions and very smooth laminar flow is created. In this configuration the fish are drawn towards the diffuser 1030, and from there swim down into the conversion zone 1020. The pump suction current comes in part from the diffuser 1030 and in part from water drawn through a water gate 1050. In the embodiment of FIG. 10, the water diffuser 1030 is positioned behind the pump suction 1040 inlet to produce the conversion zone 1020 below and behind the attraction zone 1010.

FIG. 11 is a side or top view of an embodiment of a fish pump loading system according to the present disclosure for generating water flow and creating an attraction zone 1110 and a conversion zone 1120, where the pump suction 1140 is adjacent at least two water flow generators 1130, for example water diffusers. In particular, FIG. 11 shows another embodiment of a fish pump loading system, in which the pump suction 1140 inlet is flanked by at least two diffusers 1130. Such an embodiment may be suitable for an application where the system needs to be used in a shallow water body and the diffusers are placed on either side of the pump suction, with FIG. 11 being a view from above. Alternatively, FIG. 11 may be a side view of an embodiment where the pump suction 1140 inlet is flanked by two diffusers 1130 above and below.

The embodiment of FIG. 11 may be described as having a first water flow generator and a second water flow generator, such as a first water diffuser and a second water diffuser, where the pump suction inlet is positioned between the first water diffuser and the second water diffuser to: produce the conversion zone in front of the pump suction inlet; and produce the attraction zone on both sides of the conversion zone in front of the first and second water diffusers. The attraction zone extends beyond the conversion zone at a distance beyond the pump suction inlet.

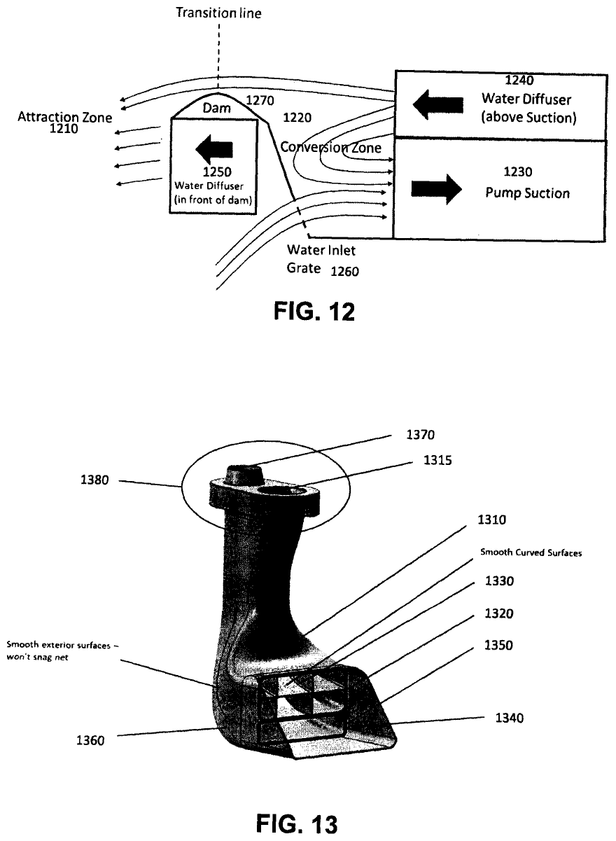

FIG. 12 illustrates a side view of an embodiment of a fish pump loading system according to the present disclosure for generating water flow and creating an attraction zone 1210 and a conversion zone 1220, where the system includes a physical dam structure 1270 between the attraction zone 1210 and the conversion zone 1220. In particular, FIG. 12 shows another embodiment of a fish pump loading system having a physical dam structure 1270 between the attraction zone 1210 and conversion zone 1220. In this embodiment, water is passed over the dam 1270 and/or out from the front of the dam to create the attraction current. The pump suction current comes in part from the water flow generator 1240 (such as a water diffuser) and in part from water drawn through a water grate 1260 that bypasses the dam.

The embodiment of FIG. 12 may be described as having a first water flow generator and a second water flow generator. In an example embodiment, the first water flow generator may comprise a water diffuser 1240 positioned above the pump suction inlet 1230. The second water flow generator may comprise a second water diffuser 1250 positioned in front of the pump suction inlet 1230 and in front of a dam 1270 located in front of the pump suction inlet 1230 and after an upward water inlet gate 1260, to: produce the conversion zone 1220 in front of a lower portion of the water diffuser 1240 and in front of the entire pump suction inlet 1230 as well as between the pump suction inlet 1230 and the upward water inlet grate 1260; and produce the attraction zone 1210 above the conversion zone 1220 and above and in front of the second water diffuser 1250 in front of the dam 1270.

The creation of the attraction and conversion zones of water flow depends on a number of factors. The water flow generator and pump suction inlet may be positioned in proximity to each other such that draw to the pump suction inlet alters the flow created by the water flow generator, creating the attraction and conversion zone flows (shown in FIG. 8 through FIG. 12). In an embodiment, the result may be a gradient of laminar flows or multiple tiered water flows, a portion of which wraps tightly back to the pump suction creating the fast moving conversion current, and a second portion of which is jetted outwards creating an attraction current. In another embodiment, such as in FIG. 9, the result includes cross-flows, where a narrow fast moving flow may be jetted through a slower moving diffuse flow and the direction of flows are close to perpendicular, creating a conversion zone within an attraction zone. The attraction current may also be induced in the surrounding environment by the water flows generated by the water flow generator and pump inlet suction.

Further, in one or more embodiments herein disclosed, Computation Fluid Dynamics (CFD) modelling may be used to tune the geometry of the apparatus in order to adapt to a variety of operating conditions and fit this solution to a range of existing equipment. The water diffuser nozzle and pump suction inlet may be positioned in proximity to each other such that draw to the pump suction inlet alters the flow exiting the water diffuser, creating the attraction and conversion zone flows. The result is a gradient of laminar flows or multiple tiered water flows, a portion of which wraps tightly back to the pump suction creating the fast moving conversion current, and a second portion of which is jetted outwards creating an attraction current. The attraction current may also be induced in the surrounding environment by the water flows generated by the water diffuser and pump inlet suction.

FIG. 13 illustrates a perspective view of an embodiment of a fish pump loading system according to the present disclosure. In particular, FIG. 13 shows an embodiment that may be used, for example, as a sea site drop-in unit. In other words, the embodiment of FIG. 13 may be submerged in a body of water, such as a sea cage for fish. This unit may be designed to adapt to and interact with existing fish pump equipment.

As described in relation to FIG. 8, the embodiment of FIG. 13 comprises a water flow generator, which may be provided as a water diffuser 1310 having a water diffuser inlet 1315 configured to receive a second input water stream that is independent of the first input water stream (water and fish), and a water diffuser nozzle 1320 configured to diffuse the second input water stream at an outlet of the water diffuser to produce a dispersed output water stream. In an embodiment, the water diffuser is positioned and constructed such that the water diffuser nozzle is perpendicular to the second input water stream. In an embodiment, the water flow generator comprises a water diffuser having a curved construction, for example a J-shape, an L-shape, or a C-shape.

In an embodiment, the water flow generator comprises a plurality of deflector fins 1330 configured to shape and direct water. In an example embodiment, the water flow generator comprises a water diffuser including a plurality of deflector fins positioned to create a set of diffusion chambers. The plurality of deflector fins may be positioned to create a plurality of rectangular diffusion chambers including: a first set of top diffuser chambers; and a second set of bottom diffuser chambers provided below the first set of top diffuser chambers. The example embodiment of FIG. 13 is illustrated with six diffuser chambers. It will be understood that, in one or more embodiments, the diffusion chambers of FIG. 13, including top diffuser chambers and bottom diffuser chambers, may instead be considered water flow generator chambers, including top flow generator chambers and bottom flow generator chambers.

In an embodiment, a water flow generator nozzle (such as the diffuser nozzle of FIG. 13) includes smooth, curved surfaces and a plurality of deflector fins for generating water flow having desirable characteristics. The characteristics of the water flow generator may be tuned to optimize these flow characteristics, as described in more detail herein. The surrounding walls 1340 (e.g. the side and bottom walls) of the fish pump loading system of FIG. 13 may guard against the suction of undesirable items such as nets, and the body of the pump input unit may be similarly designed in smooth surfaces to avoid snagging nets. The surrounding side and/or bottom walls may also be designed to direct water flow to the pump suction inlet 1350.

As shown in FIG. 13, the system comprises a pump suction inlet 1350. In an embodiment, the pump suction inlet comprises side walls 1340 extending past a front edge of the water diffuser. The system may further comprise a pump suction concentrator 1360 provided between the pump suction inlet 1350 and the fish pump entrance interface 1370. The pump suction concentrator 1360 may be configured to concentrate the first input water stream as it approaches the fish pump entrance 1370, and may comprise smooth curved surfaces.

In FIG. 13, the pump suction concentrator is in fluid communication with an output to a fish pump 1370, for transferring water and fish. Together, the water input and output 1380 to pump of the system of FIG. 13 are configured to interface with a water source and fish pump, and may include an interface for an electrical connection. In an example embodiment, as shown in FIG. 13, the pump suction concentrator 1360 comprises: a distal end in a plane parallel to the fish pump entrance; a concentrator body having a curved configuration; and a proximal end in a plane parallel to the fish pump entrance.

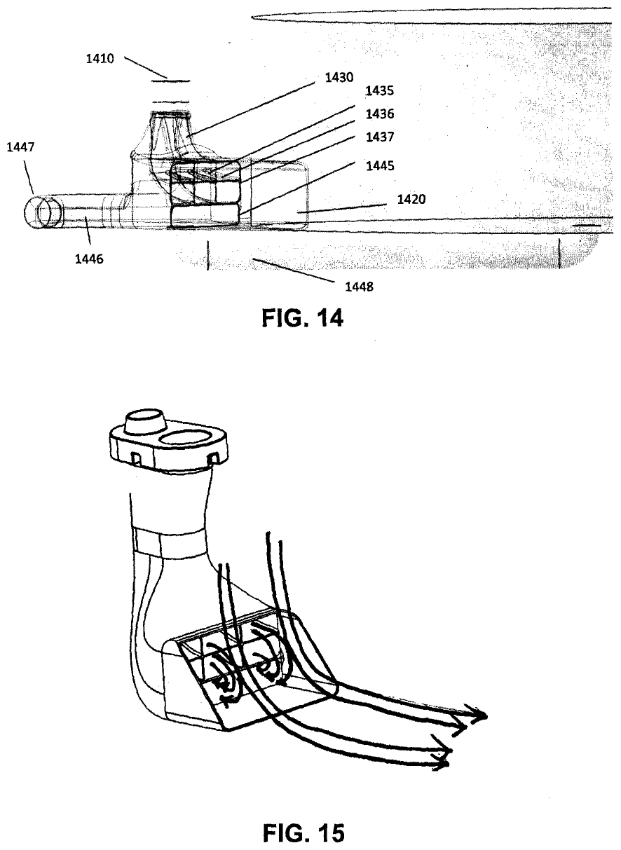

FIG. 14 illustrates a side view, partially in cross-section, of an embodiment of a fish pump loading system according to the present disclosure, coupled to a tank. FIG. 14 shows an embodiment that is a built-in option for a tank system. Like the example of FIG. 13, the unit of FIG. 14 includes a water input 1410, for example an input for conditioned water under pressure. The components of the fish pump loading system may be partially or entirely located on the outer side of the tank, and in communication with the water of the tank via a tank interface 1420, to avoid minimizing the effective volume of the tank.

As with the example of FIG. 13, FIG. 14 includes a water flow generator, for example a water diffuser 1430 having deflector fins 1435 and smooth curved surfaces 1436. The diffuser nozzle 1437 (or water flow generator nozzle), in use, generates water flow that is modified by the pump suction to create attraction and conversion flow zones. The pump suction inlet 1445 of FIG. 14 is in fluid communication with an output to a fish pump 1447 via a pump suction concentrator 1446. This example includes a secondary pump suction inlet 1448 tied directly back to the tank. This allows the diffuser 1430 (or water flow generator) to produce attraction currents that flow out into the tank. Alternatively, the unit can omit the secondary pump suction inlet 1448 and instead use water from the recirculating aquaculture system (RAS) to increase the water input pressure to support flow to both pump and tank. In an example embodiment, as shown in FIG. 14, the pump suction concentrator comprises: a distal end in a plane perpendicular to the fish pump entrance; a concentrator body having a substantially linear configuration; and a proximal end in the plane parallel to the fish pump entrance.

### Cage/Tank Interface Systems

Fish pump loading systems according to the present disclosure may include an interface for a cage or tank system, and may also interface with a guidance system. In an apparatus for use in a sea cage system, the apparatus may interface with the net system, preferably without snagging the nets or allowing net to be drawn into the pump suction inlet. The side walls 1340 and outside surface of the exemplary apparatus shown in FIG. 13 serve this function; the side walls 1340 extend out from the mouth of the pump suction inlet, stopping net from being drawn into the suction inlet. The outside surface of the apparatus shown in FIG. 13 is smooth, without any features that would catch a net that slides across the apparatus.

In an apparatus for use in a tank system, the fish pump loading system may be built into the side of the tank, becoming part of the tank wall structure (e.g. as shown in FIG. 14). In this case the apparatus walls are designed to meet the pressure handling and structural requirements of the tank, as well as the requirements for creating the attraction and conversion zones.

In an apparatus for use in a cage system or a tank system, the apparatus may include attachment points for interfacing to lifting or manipulating systems, for moving, positioning and/or operation of the apparatus.

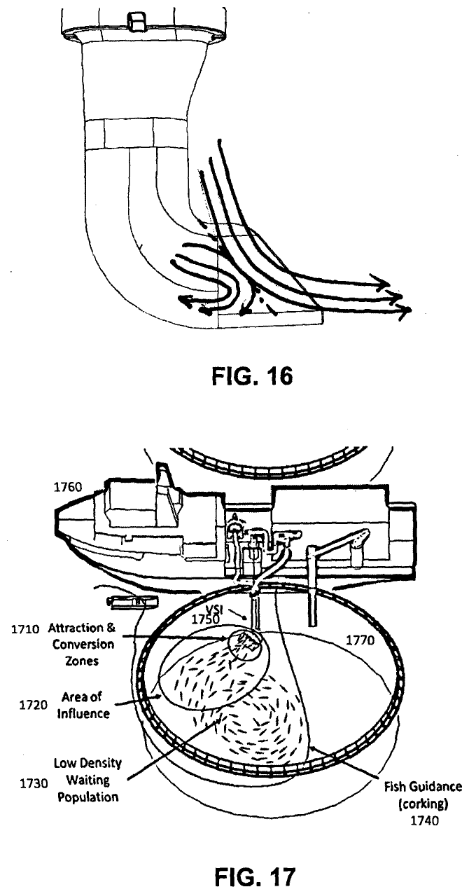

FIG. 15 illustrates a perspective view of an embodiment of a fish pump loading system in use, according to the present disclosure, where arrows indicate the direction of water flow. FIG. 16 illustrates a side view of the fish pump loading system of FIG. 15. Both FIG. 15 and FIG. 16 show detailed directions of flow to further illustrate how the system of FIG. 13 generates water flow to create attraction and conversion zones.

In one or more embodiments, the pump suction intake water may be supplied with water from outside the attraction and conversion zones. For example, as shown in FIGS. 8, 10, and 12, some embodiments have water flow into the pump suction that do not originate at the water diffuser (or water flow generator). Additional water sources may be used; for example, the system may make use of natural water currents, such as tides.

FIG. 17 shows a fish pump loading system 1750 according to an embodiment of the present disclosure in use as a drop-in sea site unit. The system may be coupled to a boat 1760. The system may be adapted to be lowered into a sea cage 1770 for fish. The system creates attraction and conversion zones 1710 adjacent an area of influence 1720 in the sea cage, where fish are present as a low-density waiting population 1730. The system may be used with any suitable means or method of fish guidance 1740, such as corking. The fish pump loading system 1750 according to embodiments of the present disclosure may be implemented differently depending on the application.

The fish pump loading system according to embodiments of the present disclosure can also be configured for use in land-based tank systems. In this case the system may be designed to be installed on the exterior of the tank, such as in FIG. 14, so as not to reduce the volume of the tank available for growth of fish. The present disclosure, in one aspect, provides a pump intake unit, which creates conditions at the entry to the pump that cause fish to voluntarily swim up to the pump where they are rapidly and safely drawn into the pump.

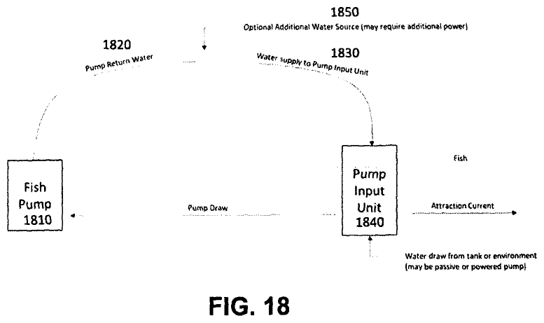

FIG. 18 shows in more detail an example of the water flow circulation involved in an exemplary fish pump loading system. The water output 1820 from a fish pump 1810 can be captured and used to provide water under pressure 1830 to the fish pump loading system 1840. Creating the fast currents in the conversion zone may require the use of much of the water under pressure, which can leave little pressure left for the creation of an attraction current. Several methods can be used to create an attraction current from the attraction zone out into the area of influence. In one or more embodiments, the fish pump loading system may be designed to create multiple tiered water flows, a portion of which wraps tightly back to the pump suction creating a fast moving conversion current, and a second portion of which is jetted outwards creating an attraction current. Since the flow in and out of the system must equilibrate over time, the system may be designed to draw additional water from the surrounding environment outside of the attraction and conversion zones, into the pump suction. In one or more embodiments, the fish pump loading system may use additional pumping capacity or water sources 1850, for example, a recirculating aquaculture system (RAS), to supplement the water input to the water management system, or directly to the fish pump loading system 1840. In one or more embodiments, the fish pump loading system may make use of natural currents or tides, existing within a cage environment where designs may be positioned such that the natural water movement creates a current in the desired direction. In one or more embodiments, the fish pump loading system may include a separate apparatus, such as a water pump, to generate an attraction current that flows outwards from the intake unit and supplements any current produced by the intake unit.

In one or more embodiments, the interface between the attraction zone and conversion zone created by a fish pump loading system may be designed to have low turbulence and not disturb fish. The system may incorporate design features, such as current, light, geometry and other factors so that fish cross into the conversion zone before encountering the flow stimuli that would cause them to attempt to reverse course. Once they enter the conversion zone, an attempt to reverse course will only accelerate their entrance into the fish pump suction. For the fish, an impetus for moving from the attraction zone to the conversion zone is to continue to seek the source of the flow and to continue forward movement, with the remaining school of fish coming up from behind. Accordingly, different embodiments of the present disclosure generating different positioning of the attraction and conversion zones may be used in different scenarios, for example depending on the species of fish, the type of enclosure, type of pump, etc. There are fish species, for example farmed trout, that may prefer to move upwards rather than downwards, or downstream rather than upstream. In the exemplary embodiment outlined in FIG. 8, the positioning of the conversion zone below the attraction zone may exploit the instinctive response of the target fish to dive down into the conversion zone. In this way, stressing or startling the fish may be avoided. A benefit of the system is reduced fish stress.

The fish pump loading system may include an apparatus with several functions, to produce attraction and conversion zones.

In an implementation, embodiments of the present disclosure are provided as separate a fish pump loading system, which can be retrofitted for use with any number of existing fish pumps. This provides an advantage of ease of installation, and leveraging existing investments in different fish pump systems, and enhances the operation of the fish pump systems without modifying the underlying system, and simply adding the fish pump loading system as a peripheral system.

In another implementation, the present disclosure provides a fish pump that includes an integrated fish pump loading system, such that a customer acquiring a new fish pump, such as to replace an existing fish pump or a brand new installation, acquires a fish pump that has an integrated fish pump loading system.

Further example embodiments will now be described with respect to various components of the fish pump loading system.

### Water Flow Generators

One or more water flow generators may be used in the fish pump loading systems herein disclosed. Water flow generators may take an input stream of pressurized water, such as from a circular pipe. In an embodiment, the water flow generator(s) takes as input a stream of pressurized water and uses one or more of nozzle geometries, deflector fins and smooth complex curved surfaces to project the input water into one or more flow streams. The projected flow streams are jetted outwards from one or more nozzle outputs at one or more angles. The water flows combine with pump suction flow(s) and environmental water flows to create the attraction and conversion zones. The water flow generator may take the form of a combination of one or more diffusers and/or concentrators. Water diffusers convert the input water stream into a slower more diffuse water flow. Water concentrators create higher velocity more narrowly focused streams of water flow. For example, in relation to the exemplary embodiments, water diffusers may be said to create a dispersed output water stream. It will be understood that water flow generators, more generally, create a modified output water stream. In embodiments where the water flow generator is a water flow concentrator, the water flow generator may be said to create a concentrated output water stream.

In an embodiment in which the water flow generator comprises a diffuser, the fish pump loading system may include deflector fins and smooth complex curved surfaces to diffuse the input water into a dispersed flow stream that is jetted outwards from a diffuser nozzle. The flow characteristics of the output stream are a function of several factors, including the size of the water inlet, the water pressure, the shape of the water diffuser and diffuser fins, and the surface characteristics of the water diffuser structure. The water diffuser(s) may function to create diffuse laminar flow out of the diffuser nozzle generating the flow patter required to create effective attraction and conversion zones. The shape of the diffuser may be tuned to optimize the flow pattern of the water output from the diffuser nozzle. In one or more embodiments, the water diffuser includes a plurality of deflector fins. The size, positioning, and quantity of deflector fins may be tuned to optimize the diffuse laminar flow out of the diffuser nozzle, including the direction and velocity of the flow. The deflector fins may be configured to create diffuse laminar flow while minimizing turbulence.

In one or more embodiments, the water diffuser may be positioned with respect to the pump suction inlet to create a laminar flow. The laminar flow may comprise a first portion of which wraps tightly back to the pump suction inlet creating the second fast-moving conversion current; and a second portion of which is jetted outwards creating the attraction current. The water diffuser may be positioned and constructed such that the water diffuser nozzle is perpendicular to the second input water stream. The water diffuser may have a curved construction. The water diffuser may have a J-shape, an L-shape, or a C-shape construction. The water diffuser may comprise a plurality of deflector fins. The plurality of deflector fins may be positioned to create a set of diffusion chambers. The plurality of deflector fins may be positioned to create a plurality of rectangular diffusion chambers including: a first set of top diffuser chambers; and a second set of bottom diffuser chambers provided below the first set of top diffuser chambers. The water diffuser may comprise smooth and/or curved surfaces. The plurality of deflector fins may comprise smooth and/or curved surfaces.

In one or more embodiments, the water diffuser may be positioned above the pump suction inlet to produce the conversion zone below the attraction zone. The water diffuser may be positioned below the pump suction inlet to produce the conversion zone above the attraction zone. The water diffuser may be positioned beside the pump suction inlet to produce the conversion zone beside the attraction zone. The water diffuser may be positioned behind the pump suction inlet to produce the conversion zone below and behind the attraction zone. The water diffuser may comprise more than one water diffusers. The water diffuser may comprise a first water diffuser and a second water diffuser; and the pump suction inlet may be positioned between the first water diffuser and the second water diffuser to produce the conversion zone in front of the pump suction inlet and to produce the attraction zone on both sides of the conversion zone in front of the first and second water diffusers, the attraction zone extending beyond the conversion zone at a distance beyond the pump suction inlet. The water diffuser may comprise a first water diffuser and a second water diffuser; and the first water diffuser may be positioned above the pump suction inlet; and the second water diffuser may be positioned in front of the pump suction inlet and in front of a dam located in front of the pump suction inlet and after an upward water inlet grate, to produce the conversion zone in front of a lower portion of the water diffuser and in front of the entire pump suction inlet as well as between the pump suction inlet and the upward water inlet grate, and to produce the attraction zone above the conversion zone and above and in front of the second water diffuser in front of the dam.

### Pump Suction Intake

The fish pump loading system according to one or more embodiments herein may include a pump suction intake as an input to a pump suction pipe. The pump suction intake may be designed with smooth curved surfaces to safely transition fish into the fish pump suction, for example to draw fish through the pump suction inlet, from the conversion zone.

In an example embodiment, the fish pump loading system may comprise a flow concentrator positioned to draw through the pump suction inlet from the conversion zone. Fish and water may be drawn into the flow concentrator and fed into a pump inlet pipe. The pump suction concentrator may reduce the flow aperture down to pump input piping size, accelerating water flow. The shape, size, positioning, etc. of the pump suction concentrator may influence the flow characteristics of the suction inlet flow. The pump suction inlet and concentrator may be tuned to optimize the pattern and rate of flow of water into the pump suction inlet. The pump suction inlet and concentrator may be optimized to reduce turbulence. The pump suction inlet and concentrator may be optimized to create a flow rate in a range that provides rapid safe transition of fish from the conversion zone into the pump suction.

In one or more embodiments, the pump suction concentrator may intake water at a first velocity and accelerate the water flow to a second velocity. The first velocity may be about 0.7 m/s, such as about 0.5 m/s to about 1.0 m/s, or about 0.5 m/s to about 0.75 m/s, or about 0.75 m/s to about 1.0 m/s, or about 0.6 m/s to about 0.8 m/s. The second velocity may be about 2.0 m/s, such as about 1.5 m/s to about 2.5 m/s, or about 1.5 m/s to about 2.0 m/s, or about 2.0 to about 2.5 m/s, or about 2.0 to about 3.0 m/s. The first and second velocities may be any suitable flow rate against which the fish cannot effectively swim.

The relative location of the water flow generator output(s) and pump suction inlet(s), along with the flow patterns produced by the water flow generator(s) and pump suction condenser(s) may be used to optimize the attraction and conversion zones, and a non-turbulent transition area between said zones. The interrelation between these factors is not a simple sum of parameters, but rather a complex 3-dimensional interaction that is challenging to predict or optimize. The present disclosure has developed core principles, and utilizes computational fluid dynamics simulations to model and optimize these complex interactions, in order to design the fish pump loading systems herein disclosed.

The pump suction inlet may comprise surrounding walls (e.g. side walls and floor) extending past a front edge of the water flow generator. The pump suction inlet may include a pump suction concentrator. The pump suction concentrator may be provided between the pump suction inlet and the fish pump entrance interface, the pump suction concentrator configured to concentrate the first input water stream as it approaches the fish pump entrance. The pump suction concentrator may comprise smooth and/or curved surfaces. The pump suction concentrator may comprise a distal end in a plane parallel to the fish pump entrance; and a concentrator body having a curved configuration; and a proximal end in a plane parallel to the fish pump entrance. The pump suction concentrator may comprise a distal end in a plane perpendicular to the fish pump entrance; and a concentrator body having a substantially linear configuration; and a proximal end in the plane parallel to the fish pump entrance.

### Pump Embodiments

The fish pump loading system of embodiments of the present disclosure can be configured to use no additional power or water beyond the discharge water from the pumping system it will support. For example, FIG. 13 illustrates a perspective view of an embodiment of a fish pump loading system according to the present disclosure. FIG. 13 shows an embodiment that may be used, for example, as a sea site drop-in unit. In other words, the embodiment of FIG. 13 may be submerged in a body of water, such as a sea cage for fish. This unit may be designed to adapt to and interact with existing fish pump equipment (together with a water management system). Such an apparatus may have the benefits of requiring no additional power generation and using no moving parts.

The embodiment of FIG. 13 comprises a water diffuser 1330 having a water diffuser inlet 1370 configured to receive a second input water stream that is independent of the first input water stream (water and fish), and a water diffuser nozzle 1320 configured to diffuse the second input water stream at an outlet of the water diffuser to produce a dispersed output water stream. In an embodiment, the water diffuser input of the fish pump loading system of FIG. 13 is configured to receive conditioned water under pressure, for example from an output of the fish pump. In an embodiment, the water diffuser is positioned and constructed such that the water diffuser nozzle is perpendicular to the second input water stream. In an embodiment, the water diffuser has a curved construction, for example a J-shape, an L-shape, or a C-shape.

### Fish Guidance and Water Management

Fish pump loading systems according to the present disclosure may include a fish guidance device. In an example embodiment, a fish guidance device comprises a structure or feature that allows the passage of water and currents but not of fish. The fish guidance device may be used to guide the fish travelling through the attraction zone to the conversion zone. In an example embodiment, the fish guidance system comprises a system of bars spaced closely enough that fish cannot pass through, but when placed in the attraction zone, will not impede the movement of the attraction current or the passage of light into the attraction zone.

FIG. 19 shows an example of a sea cage implementation of an embodiment of the present disclosure. In this example embodiment, a cork line 1910 is used to reduce the net pocket 1920 size and guide the fish population towards the fish pump loading system 1930, or Pump Intake unit. As the fish swim into the Pump Intake Unit 1930 and the waiting population shrinks, the net is drawn over the cork line, keeping the fish population within range of the Pump Intake Unit. The maintenance density of the local population is chosen such that it does not threaten the health of the local fish population, but does result in the voluntary movement of fish from the local population into the attraction zone at a target fish transfer rate.

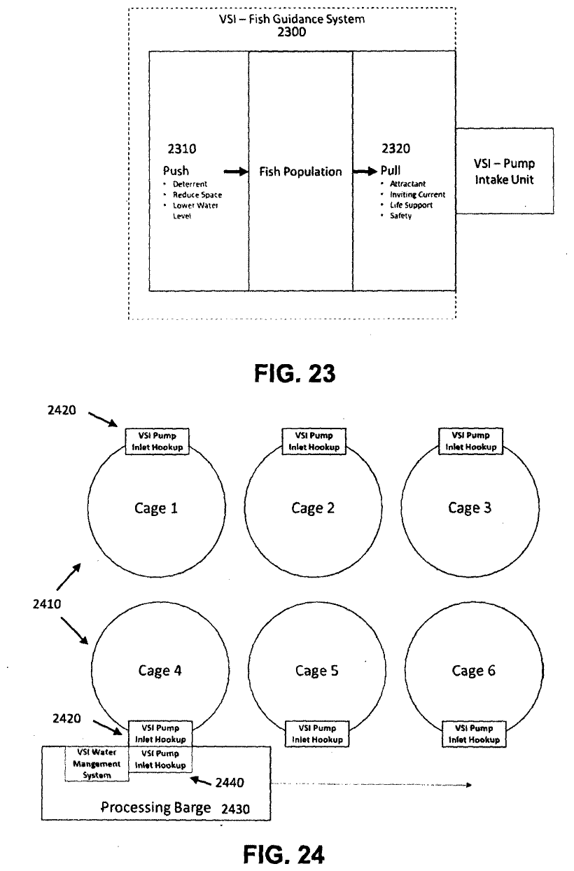

In one or more embodiments, the fish pump loading system may operate in cooperation with a Fish Guidance System 2300, an example of which is shown in FIG. 23. A fish guidance system may be used to bring the population of fish into proximity of the pump intake unit. In contrast to the current fish crowding practices, the fish guidance system maintains the fish population in healthy conditions. The pump intake unit may be adapted to generate the required current and attractants required to draw the fish from the guided population, into the pump intake system.

In one or more embodiments, the fish pump may include an integrated fish pump loading system, such that a customer acquiring a new fish pump, such as to replace an existing fish pump or a brand new installation, acquires a fish pump that has an integrated fish pump loading system. In an example embodiment, the fish pump loading system is integrated with the fish pump system such that a water output of the fish pump is used as the second water input for the water diffuser of the fish pump loading system.

The system may also include an interface to a fish guidance system 2300. This interface may be a changeable or moveable interface whose function is to guide the final members of the fish population into the pump inlet, when the majority of the population has already been drawn into the pump and only a small number of fish remain.

In one or more embodiments, the fish pump loading system may use sound waves, electricity or other stimuli to guide fish 2310. Additional stimuli may be introduced as a deterrent to leaving the attraction zone in a direction away from the conversion zone.

FIG. 20 is an overview of an exemplary fish pump loading system according to an embodiment of the present disclosure, and how the system may incorporate pump intake units 2030. Two of the components, the fish guidance system 2020 and water management system 2040, may replace or augment existing functions within standard fish pumping systems, while the pump intake unit 2030 represents a new function and component, not present in existing fish pumping systems. In one embodiment, the system has a central pump intake unit, or fish pump loading system 2030. This unit may use water returning under pressure from the water management system 2040, to create flow characteristics that encourage fish to swim into the unit and then transition into the pump intake.

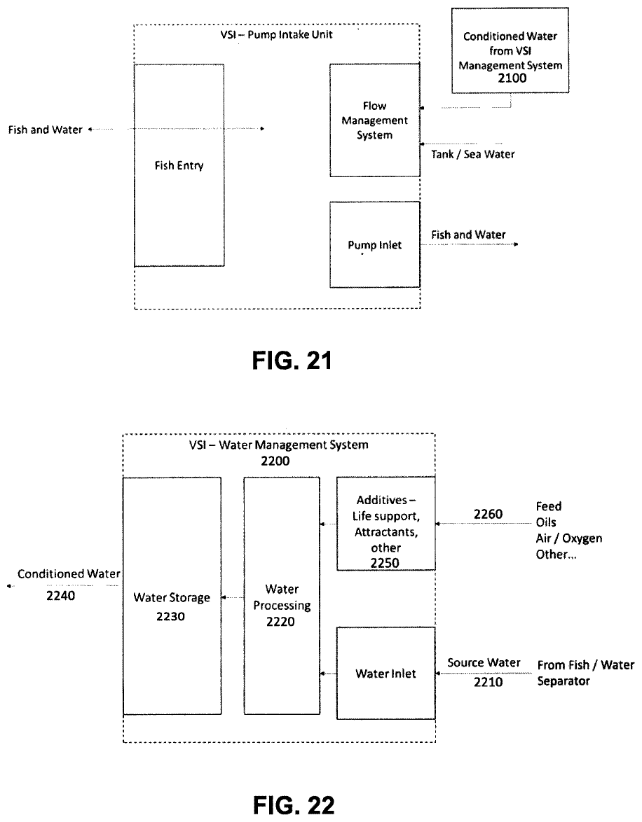

FIG. 21 illustrates flow of water for an embodiment of a fish pump loading system according to the present disclosure. FIG. 22 illustrates a water management system 2200 for use with a fish pump loading system according to one or more embodiments of the present disclosure. As outlined in FIG. 21 and FIG. 22, the water management system may recover the water output from a fish pump 2210 and/or perform water conditioning 2220. The water management system may hold an inventory of water 2230 at a height sufficient to feed conditioned water 2240 to a Pump Intake Unit at the required pressure to operate the Pump Intake Unit or fish pump loading system.

FIG. 23 illustrates a fish guidance system 2300 for use with a fish pump loading system according to one or more embodiments of the present disclosure. As described earlier, in one or more embodiments the fish guidance system as shown in FIG. 23 may operate in cooperation with a fish pump loading system, shown as a VSI pump intake unit. In another embodiment, the fish guidance system as shown in FIG. 23 may operate in cooperation with a fish pump loading system such as shown and described in relation to FIG. 19 and FIG. 20.

### Water Flow

In one or more embodiments, fish pump loading system creates an attraction current having an attractive velocity or flow rate. The attractive flow rate may be any suitable flow rate for attracting fish. The attractive flow rate may be based on the body length of the fish (i.e. body length per second). The attractive flow rate may be about 1 body length per second. The attractive flow rate may be about 0.5 to about 2 body lengths per second, such as about 0.5 to about 1.5 body lengths per second, or about 0.75 to about 1.25 body lengths per second.

The fish pump loading system according to one or more embodiments may be designed to match the volume and pressure of the input water, which is determined by the output of the pump and any additional water sources in use. The fish pump loading system may be designed to operate within the parameters of existing water source inputs. The fish pump loading system may be designed to adjust the parameters of the water source inputs, such as the water pressure. The size of piping used in the fish pump loading system and/or associated interfaces and apparatus may be optimized to be compatible with, or to modify, the volume and pressure of the input water. The piping size used in the fish pump loading system may be designed to match the system to which it will be fitted, such as an existing fish tank or sea cage. In one or more embodiments, the fish pump loading system is to be used with an existing fish pump. In such a case, the parameters of the fish pump may determine the size of piping and volume/pressure of water. Furthermore, the system may be optimized to the type, size, and quantity of fish to be transferred. For example, the size of fish to be transferred may dictate the optimal piping size and fish pump parameters to be used.

### Additional Fish Attractants

In one or more embodiments, the fish pump loading system may use light to attract fish. One or more light sources may be included in the pump suction inlet. These light sources may be positioned, and the wavelength of light configured, to make the pump suction inlet attractive to the fish by making it appear like a natural passage that the fish instinctively follow in search of a desirable environment.

Material selection, colour and surface conditions of the apparatus may be tailored to increase the attractiveness to fish. For example, paint, material type, and surface treatment may be used to change the surfaces of the apparatus that are visible to the fish as they move from attraction to conversion zones, in order to make the path into the conversion zone more attractive to the fish.

Additional examples of attractants may include: colour and surface conditions of the apparatus; geometry and relative position of the apparatus and zones. Attractants may include use of sound waves, electricity or other stimuli to guide fish 2310. The fish pump loading system may include an apparatus for attracting fish 2320, such as a source of sound waves, electricity, or other stimuli. The fish pump loading system may be used in cooperation with a separate apparatus, the apparatus for creating a deterrent, driving fish away and toward the fish pump loading system, such as a source of sound waves, electricity, or other stimuli.

In one or more embodiments, the fish pump loading system may use of feed or oils to attract fish 2320. Feed, oils or other attractants may be added to the source water 2250, to increase the attractiveness of attraction current to the fish in the source population. The fish pump loading system may comprise an inlet or an input 2260 for receiving an additive, such as feed or oils to attract fish. The fish pump loading system may comprise an inlet for receiving an additive and an apparatus for conditioning input water with the additive 2250. The fish pump loading system may dilute an additive, or it may inject the additive directly into the surrounding water. The additive may be present in the attraction zone generated by the fish pump loading system. The additive may be a solid, liquid or gas. The additive may be a gas, such as oxygen. The additive may include food, nutrients, or bioactive compounds such as drugs.

### Fish Transfer

FIG. 24 illustrates a top view of a plurality of sea cages 2410 for fish, each integrating an embodiment of a fish pump loading system 2420. A source of inefficiency in current sea cage fish transfer practices is in the time and labour required to setup transfer once the processing vessel has arrived at the sea cage. The fish pump loading systems according to embodiments of the present disclosure can be designed to maximize the efficiency of the processing vessel by outfitting each cage with a fish pump loading system that is in place either permanently or installed prior to arrival of the vessel. In this case, the processing vessel 2430 outfitted with the fish pump loading system can rapidly pull up to a sea cage 2410, hook up to the fish pump loading system 2420 and begin fish transfer immediately. An example of such a setup is presented in FIG. 24, where six sea cages 2410 each include a fish pump loading system 2420. FIG. 24 shows Cage 4 interfacing with a processing barge equipped with a pump inlet hookup 2440 for cooperating with a pump inlet hookup 2420.

As described and illustrated herein, in an embodiment the present disclosure provides a fish pump loading system comprising: a pump suction inlet configured to receive a first input water stream including a combination of fish and water; at least one water flow generator comprising: a water flow generator inlet configured to receive a second input water stream that is independent of the first input water stream; and a water flow generator nozzle configured to modify the second input water stream at an outlet of the water flow generator to produce a modified output water stream. The water flow generator is positioned in proximity to the pump suction inlet such that the first input water stream interacts with and alters the modified output water stream to produce: an attraction zone to draw upstream-swimming fish towards the pump suction inlet, the attraction zone having a first attraction current; and a conversion zone adjacent the attraction zone and having a second fast-moving conversion current drawing into the pump suction inlet to rapidly convert the fish into the first input water stream after the fish swim into the conversion zone. The system comprises a pump suction outlet configured to transmit the combination of fish and water to a fish pump entrance.

In an embodiment, the at least one water flow generator comprises a water concentrator, and the water concentrator comprises: a water concentrator inlet configured to receive the second input water stream; and a water concentrator nozzle configured to concentrate the second input water stream at the outlet of the water flow generator to produce the modified output water stream.

In another embodiment, the at least one water flow generator comprises a water diffuser, and the water diffuser comprises: a water diffuser inlet configured to receive the second input water stream; and a water diffuser nozzle configured to diffuse the second input water stream at the outlet of the water flow generator to produce the modified output water stream.

In another embodiment, the at least one water flow generator comprises at least one water concentrator configured to create a water jet, the water concentrator positioned behind the pump suction inlet to create a cross-flow such that the second fast-moving conversion current passed through the first attraction current which is diffuse.

In another embodiment, the conversion zone is created at an intersection of the second fast-moving conversion current and the first attraction current.

In another embodiment, a fish guidance device is configured to direct fish moving along the attraction current to the cross-flow.

In another embodiment, a water diffuser is configured to create the diffuse first attraction current.

In another embodiment, the water flow generator is positioned with respect to the pump suction inlet to create a laminar flow.

In another embodiment, the laminar flow comprises: a first portion of which wraps tightly back to the pump suction inlet creating the second fast-moving conversion current; and a second portion of which is jetted outwards creating the attraction current.

In another embodiment, the water flow generator is positioned and constructed such that the water flow generator nozzle is perpendicular to the second input water stream.

In another embodiment, the water flow generator has a curved construction selected from the group consisting of: a J-shape, an L-shape, a C-shape.

In another embodiment, the water flow generator comprises a plurality of deflector fins.

In another embodiment, the water flow generator comprises a water diffuser including plurality of deflector fins positioned to create a set of diffusion chambers.

In another embodiment, the plurality of deflector fins are positioned to create a plurality of rectangular diffusion chambers including: a first set of top diffuser chambers; and a second set of bottom diffuser chambers provided below the first set of top diffuser chambers.

In another embodiment, the water flow generator comprises smooth curved surfaces.

In another embodiment, the plurality of deflector fins comprise smooth curved surfaces.

In another embodiment, the pump suction inlet comprises side walls extending past a front edge of the water flow generator.

In another embodiment, a pump suction intake is provided between the pump suction inlet and the fish pump entrance interface, the pump suction intake configured to safely transition fish into the fish pump suction.

In another embodiment, the pump suction intake comprises a pump suction concentrator configured to concentrate the first input water stream as it approaches the fish pump entrance.

In another embodiment, the pump suction intake comprises smooth curved surfaces.

In another embodiment, the pump suction concentrator comprises: a distal end in a plane parallel to the fish pump entrance; a concentrator body having a curved configuration; and a proximal end in a plane parallel to the fish pump entrance.

In another embodiment, the pump suction concentrator comprises: a distal end in a plane perpendicular to the fish pump entrance; a concentrator body having a substantially linear configuration; and a proximal end in the plane parallel to the fish pump entrance.

In another embodiment, the water flow generator is positioned above the pump suction inlet to produce the conversion zone below the attraction zone.

In another embodiment, the water flow generator is positioned below the pump suction inlet to produce the conversion zone above the attraction zone.

In another embodiment, the water flow generator is positioned beside the pump suction inlet to produce the conversion zone beside the attraction zone.

In another embodiment, the water flow generator is positioned behind the pump suction inlet to produce the conversion zone below and behind the attraction zone.

In another embodiment, the water flow generator comprises a first water diffuser and a second water diffuser; and the pump suction inlet is positioned between the first water diffuser and the second water diffuser to produce the conversion zone in front of the pump suction inlet and to produce the attraction zone on both sides of the conversion zone in front of the first and second water diffusers, the attraction zone extending beyond the conversion zone at a distance beyond the pump suction inlet.

In another embodiment, the water flow generator comprises a first water diffuser and a second water diffuser; and the first water diffuser is positioned above the pump suction inlet; and the second water diffuser is positioned in front of the pump suction inlet and in front of a dam located in front of the pump suction inlet and after an upward water inlet grate, to produce the conversion zone in front of a lower portion of the water diffuser and in front of the entire pump suction inlet as well as between the pump suction inlet and the upward water inlet grate, and to produce the attraction zone above the conversion zone and above and in front of the second water diffuser in front of the dam.

In another aspect is provided a fish pump loading system comprising: a fish loading apparatus having a fish loading inlet and a fish outlet; a water flow generator having a water inlet and a flow generator outlet; a fish loading flow path communicating with the fish loading inlet and the fish outlet to receive a first input water stream including a combination of fish and water and to transmit the combination of fish and water to a fish pump entrance; a water modification flow path communicating with the water inlet and the flow generator outlet to receive a second input water stream independent of the first input water stream and to produce a modified output water stream; the water modification flow path interacting with the fish loading flow path to produce: an attraction zone to draw upstream-swimming fish towards the fish pump entrance, the attraction zone having a first attraction current; and a conversion zone adjacent the attraction zone and having a second fast-moving conversion current drawing into the fish pump entrance to rapidly convert the fish into the fish pump entrance after the fish swim into the conversion zone.

In another embodiment, the water flow generator comprises a water concentrator, and the water concentrator comprises: a water concentrator inlet configured to receive the second input water stream; and a water concentrator nozzle configured to concentrate the second input water stream at the outlet of the water flow generator to produce the modified output water stream.

In another embodiment, the water flow generator comprises a water diffuser, and the water diffuser comprises: a water diffuser inlet configured to receive the second input water stream; and a water diffuser nozzle configured to diffuse the second input water stream at the outlet of the water flow generator to produce the modified output water stream.

In another embodiment, the at least one water flow generator comprises a water concentrator, and the water concentrator comprises: a water concentrator inlet configured to receive the second input water stream; and a water concentrator nozzle configured to concentrate the second input water stream at the outlet of the water flow generator to produce the modified output water stream.

In another aspect is provided a fish pump loading system comprising: a pump suction inlet configured to receive a first input water stream including a combination of fish and water; at least one water flow generator comprising: a water flow generator inlet configured to receive a second input water stream that is independent of the first input water stream; and a water flow generator nozzle configured to modify the second input water stream at an outlet of the water flow generator to produce a modified output water stream; the water flow generator being positioned in proximity to the pump suction inlet such that the first input water stream interacts with and alters the modified output water stream to produce: a conversion zone having a first fast-moving conversion current drawing into the pump suction inlet to rapidly convert the fish into the first input water stream after the fish swim into the conversion zone; and a pump suction outlet configured to transmit the combination of fish and water to a fish pump entrance.

In another embodiment, the at least one water flow generator comprises a water concentrator, and the water concentrator comprises: a water concentrator inlet configured to receive the second input water stream; and a water concentrator nozzle configured to concentrate the second input water stream at the outlet of the water flow generator to produce the modified output water stream.

In another embodiment, the at least one water flow generator comprises a water diffuser, and the water diffuser comprises: a water diffuser inlet configured to receive the second input water stream; and a water diffuser nozzle configured to diffuse the second input water stream at the outlet of the water flow generator to produce the modified output water stream.

In another embodiment, a loading zone is adjacent to the conversion zone for receiving fish and water for loading into the conversion zone.

In another embodiment, the at least one water flow generator comprises a water concentrator to create a water jet, the at least one water concentrator positioned in line with the pump suction inlet to create a cross-flow in the loading zone such that the first fast-moving conversion current passes through the loading zone, the loading zone having a second slower-moving current which is diffuse for creating a path into the conversion zone for the first input water stream.

In another embodiment, there is at least one water flow generator comprising at least one water concentrator to create a water jet, the water concentrator positioned in line with the pump suction inlet to create a cross-flow in the loading zone such that the first fast-moving conversion current passes through the loading zone, the loading zone having a second slower-moving current which is diffuse for creating a path into the conversion zone for the first input water stream.

In another embodiment, the conversion zone is created at an intersection of the first fast-moving conversion current and the loading zone.

In another embodiment, a fish guidance device is configured to direct fish moving through the loading zone to the cross-flow.

In another embodiment, a water diffuser is configured to create a diffuse attraction current within the loading zone.

In another embodiment, the water flow generator is positioned with respect to the pump suction inlet to create a laminar flow.

In another embodiment, the laminar flow comprises: a first portion of which wraps tightly back to the pump suction inlet creating the second fast-moving conversion current; and a second portion of which is jetted outwards creating the loading zone having a diffuse attraction current.

In another embodiment, the water flow generator is positioned and constructed such that the water flow generator nozzle is perpendicular to the second input water stream.

In another embodiment, the water flow generator has a curved construction selected from the group consisting of: a J-shape, an L-shape, a C-shape.

In another embodiment, the water flow generator comprises a plurality of deflector fins.

In another embodiment, the water flow generator comprises a water diffuser including plurality of deflector fins positioned to create a set of diffusion chambers.

In another embodiment, the plurality of deflector fins are positioned to create a plurality of rectangular diffusion chambers including: a first set of top diffuser chambers; and a second set of bottom diffuser chambers provided below the first set of top diffuser chambers.

In another embodiment, the water flow generator comprises smooth curved surfaces.

In another embodiment, the plurality of deflector fins comprise smooth curved surfaces.

In another embodiment, the pump suction inlet comprises side walls extending past a front edge of the water flow generator.

In another embodiment, a pump suction outlet is provided between the pump suction inlet and the fish pump entrance interface, the pump suction intake configured to safely transition fish into the fish pump suction.

In another embodiment, the pump suction outlet comprises a pump suction concentrator configured to concentrate the first input water stream as it approaches the fish pump entrance.

In another embodiment, the pump suction outlet comprises smooth curved surfaces.

In another embodiment, the water flow generator is positioned above the pump suction inlet to produce the conversion zone below the loading zone.

In another embodiment, the water flow generator is positioned below the pump suction inlet to produce the conversion zone above the loading zone.

In another embodiment, the water flow generator is positioned beside the pump suction inlet to produce the conversion zone beside the loading zone.

In another embodiment, the water flow generator is positioned behind the pump suction inlet to produce the conversion zone below and behind the loading zone.

In another embodiment, the water flow generator comprises a first water diffuser and a second water diffuser; and the pump suction inlet is positioned between the first water diffuser and the second water diffuser to produce the conversion zone in front of the pump suction inlet and to produce the loading zone on both sides of the conversion zone in front of the first and second water diffusers, the loading zone extending beyond the conversion zone at a distance beyond the pump suction inlet.

In another embodiment, a dam is located in front of the pump suction inlet and after an upward water inlet grate, to produce the conversion zone in front of a lower portion of the water diffuser and in front of the entire pump suction inlet as well as between the pump suction inlet and the upward water inlet grate, and to produce the loading zone above the conversion zone and above and in front of the second water diffuser in front of the dam, wherein the water flow generator comprises a first water diffuser and a second water diffuser; and the first water diffuser is positioned above the pump suction inlet; and the second water diffuser is positioned in front of the pump suction inlet and in front of the dam.

In another embodiment, a dam is located in front of the pump suction inlet and after an upward water inlet grate, to produce the conversion zone in front of a lower portion of the water diffuser and in front of the entire pump suction inlet as well as between the pump suction inlet and the upward water inlet grate and to produce the loading zone above the conversion zone and above and in front of the second water diffuser in front of the dam. At least one water flow generator has a first water diffuser positioned above the pump suction inlet, the at least one water flow generator is positioned to create an attraction current that flows over and outwards from the dam, creating an attraction zone in front of and above the dam.

In another embodiment, a second water flow generator is positioned proximal to the dam for creating an additional attraction current across the dam.

In another embodiment, a second water flow generator further comprises a second water diffuser positioned proximal to the dam for creating an additional attraction current across the dam.

In another embodiment, the water flow generator comprises a water concentrator, and the water concentrator comprises: a water concentrator inlet configured to receive the second input water stream; and a water concentrator nozzle configured to concentrate the second input water stream at the outlet of the water flow generator to produce the modified output water stream.

In another embodiment, the water flow generator comprises a water diffuser, and the water diffuser comprises: a water diffuser inlet configured to receive the second input water stream; and a water diffuser nozzle configured to diffuse the second input water stream at the outlet of the water flow generator to produce the modified output water stream.

In another embodiment, the water flow generator further comprises a second water diffuser positioned proximal to the dam for creating an additional attraction current across the dam.

In another aspect is provided a fish pump loading system comprising: a fish loading apparatus having a fish loading inlet and a fish outlet; a water flow generator having a water inlet and a flow generator outlet; a fish loading flow path communicating with the fish loading inlet and the fish outlet to receive a first input water stream including a combination of fish and water and to transmit the combination of fish and water to a fish pump entrance; a water modification flow path communicating with the water inlet and the flow generator outlet to receive a second input water stream independent of the first input water stream and to produce a modified output water stream; the water modification flow path interacting with the fish loading flow path to produce: a conversion zone having a first fast-moving conversion current drawing into the fish pump entrance to rapidly convert the fish into the fish pump entrance after the fish swim into the conversion zone; and a loading zone adjacent the conversion zone having a second slower moving current, to draw upstream-swimming fish towards the conversion zone.

In another embodiment, the water flow generator comprises a water concentrator, and the water concentrator comprises: a water concentrator inlet configured to receive the second input water stream; and a water concentrator nozzle configured to concentrate the second input water stream at the outlet of the water flow generator to produce the modified output water stream.

In another embodiment, the water flow generator comprises a water diffuser, and the water diffuser comprises: a water diffuser inlet configured to receive the second input water stream; and a water diffuser nozzle configured to diffuse the second input water stream at the outlet of the water flow generator to produce the modified output water stream.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

1. A fish pump loading system comprising:
a pump suction inlet configured to receive a first input water stream including a combination of fish and water;
at least one water flow generator comprising:
a water flow generator inlet configured to receive a second input water stream that is independent of the first input water stream; and
a water flow generator nozzle configured to modify the second input water stream at an outlet of the water flow generator to produce a modified output water stream;
the water flow generator being positioned in proximity to the pump suction inlet such that the first input water stream interacts with and alters the modified output water stream to produce:
an attraction zone to draw upstream-swimming fish towards the pump suction inlet, the attraction zone having a first attraction current; and
a conversion zone adjacent the attraction zone and having a second fast-moving conversion current drawing into the pump suction inlet to rapidly convert the fish into the first input water stream after the fish swim into the conversion zone; and
a pump suction outlet configured to transmit the combination of fish and water to a fish pump entrance.

2. The system of claim 1, wherein the at least one water flow generator comprises a water concentrator, and the water concentrator comprises:
a water concentrator inlet configured to receive the second input water stream; and
a water concentrator nozzle configured to concentrate the second input water stream at the outlet of the water flow generator to produce the modified output water stream.

3. The system of claim 1, wherein the at least one water flow generator comprises a water diffuser, and the water diffuser comprises:
a water diffuser inlet configured to receive the second input water stream; and
a water diffuser nozzle configured to diffuse the second input water stream at the outlet of the water flow generator to produce the modified output water stream.

4. The system of claim 1, wherein the at least one water flow generator comprises a water concentrator configured to create a water jet, the water concentrator positioned behind the pump suction inlet to create a cross-flow such that the second fast-moving conversion current passed through the first attraction current which is diffuse.

5. The system of claim 4 wherein the conversion zone is created at an intersection of the second fast-moving conversion current and the first attraction current.

6. The system of claim 4 further comprising a fish guidance device configured to direct fish moving along the attraction current to the cross-flow.

7. The system of claim 4 further comprising a water diffuser configured to create the diffuse first attraction current.

8. The system of claim 1, wherein the water flow generator is positioned with respect to the pump suction inlet to create a laminar flow.

9. The system of claim 8, wherein the laminar flow comprises:
a first portion of which wraps tightly back to the pump suction inlet creating the second fast-moving conversion current; and
a second portion of which is jetted outwards creating the attraction current.

10. The system of claim 1, wherein the water flow generator is positioned and constructed such that the water flow generator nozzle is perpendicular to the second input water stream.

11. The system of claim 10, wherein the water flow generator has a curved construction selected from the group consisting of: a J-shape, an L-shape, a C-shape.

12. The system of claim 1, wherein the water flow generator comprises a plurality of deflector fins.

13. The system of claim 12, wherein the water flow generator comprises a water diffuser including plurality of deflector fins positioned to create a set of diffusion chambers.

14. The system of claim 13, wherein the plurality of deflector fins are positioned to create a plurality of rectangular diffusion chambers including:
a first set of top diffuser chambers; and
a second set of bottom diffuser chambers provided below the first set of top diffuser chambers.

15. The system of claim 1, wherein the water flow generator comprises smooth curved surfaces.

16. The system of claim 12, wherein the plurality of deflector fins comprise smooth curved surfaces.

17. The system of claim 1, wherein the pump suction inlet comprises side walls extending past a front edge of the water flow generator.

18. The system of claim 1, further comprising a pump suction intake provided between the pump suction inlet and the fish pump entrance interface, the pump suction intake configured to safely transition fish into the fish pump suction.

19. The system of claim 18, wherein the pump suction intake comprises a pump suction concentrator configured to concentrate the first input water stream as it approaches the fish pump entrance.

20. The system of claim 19, wherein the pump suction intake comprises smooth curved surfaces.

21. The system of claim 19, wherein the pump suction concentrator comprises:
a distal end in a plane parallel to the fish pump entrance;
a concentrator body having a curved configuration; and
a proximal end in a plane parallel to the fish pump entrance.

22. The system of claim 19, wherein the pump suction concentrator comprises:
a distal end in a plane perpendicular to the fish pump entrance;
a concentrator body having a substantially linear configuration; and
a proximal end in the plane parallel to the fish pump entrance.

23. The system of claim 1, wherein the water flow generator is positioned above the pump suction inlet to produce the conversion zone below the attraction zone.

24. The system of claim 1, wherein the water flow generator is positioned below the pump suction inlet to produce the conversion zone above the attraction zone.

25. The system of claim 1, wherein the water flow generator is positioned beside the pump suction inlet to produce the conversion zone beside the attraction zone.

26. The system of claim 1, wherein the water flow generator is positioned behind the pump suction inlet to produce the conversion zone below and behind the attraction zone.

27. The system of claim 1, wherein:
the water flow generator comprises a first water diffuser and a second water diffuser; and
the pump suction inlet is positioned between the first water diffuser and the second water diffuser to produce the conversion zone in front of the pump suction inlet and to produce the attraction zone on both sides of the conversion zone in front of the first and second water diffusers, the attraction zone extending beyond the conversion zone at a distance beyond the pump suction inlet.

28. The system of claim 1, wherein:
the water flow generator comprises a first water diffuser and a second water diffuser; and
the first water diffuser is positioned above the pump suction inlet; and
the second water diffuser is positioned in front of the pump suction inlet and in front of a dam located in front of the pump suction inlet and after an upward water inlet grate, to produce the conversion zone in front of a lower portion of the water diffuser and in front of the entire pump suction inlet as well as between the pump suction inlet and the upward water inlet grate, and to produce the attraction zone above the conversion zone and above and in front of the second water diffuser in front of the dam.

29. A fish pump loading system comprising:
a fish loading apparatus having a fish loading inlet and a fish outlet;
a water flow generator having a water inlet and a flow generator outlet;
a fish loading flow path communicating with the fish loading inlet and the fish outlet to receive a first input water stream including a combination of fish and water and to transmit the combination of fish and water to a fish pump entrance;
a water modification flow path communicating with the water inlet and the flow generator outlet to receive a second input water stream independent of the first input water stream and to produce a modified output water stream;
the water modification flow path interacting with the fish loading flow path to produce:
an attraction zone to draw upstream-swimming fish towards the fish pump entrance, the attraction zone having a first attraction current; and
a conversion zone adjacent the attraction zone and having a second fast-moving conversion current drawing into the fish pump entrance to rapidly convert the fish into the fish pump entrance after the fish swim into the conversion zone.

30. The system of claim 29, wherein the water flow generator comprises a water concentrator, and the water concentrator comprises:
a water concentrator inlet configured to receive the second input water stream; and
a water concentrator nozzle configured to concentrate the second input water stream at the outlet of the water flow generator to produce the modified output water stream.

31. The system of claim 29, wherein the water flow generator comprises a water diffuser, and the water diffuser comprises:
a water diffuser inlet configured to receive the second input water stream; and
a water diffuser nozzle configured to diffuse the second input water stream at the outlet of the water flow generator to produce the modified output water stream.

32. A fish pump loading system comprising:
a pump suction inlet configured to receive a first input water stream including a combination of fish and water;
at least one water flow generator comprising:
a water flow generator inlet configured to receive a second input water stream that is independent of the first input water stream; and
a water flow generator nozzle configured to modify the second input water stream at an outlet of the water flow generator to produce a modified output water stream;
the water flow generator being positioned in proximity to the pump suction inlet such that the first input water stream interacts with and alters the modified output water stream to produce:
a conversion zone having a first fast-moving conversion current drawing into the pump suction inlet to rapidly convert the fish into the first input water stream after the fish swim into the conversion zone; and
a pump suction outlet configured to transmit the combination of fish and water to a fish pump entrance.

33. The system of claim 32, wherein the at least one water flow generator comprises a water concentrator, and the water concentrator comprises:
a water concentrator inlet configured to receive the second input water stream; and
a water concentrator nozzle configured to concentrate the second input water stream at the outlet of the water flow generator to produce the modified output water stream.

34. The system of claim 32, wherein the at least one water flow generator comprises a water diffuser, and the water diffuser comprises:
a water diffuser inlet configured to receive the second input water stream; and
a water diffuser nozzle configured to diffuse the second input water stream at the outlet of the water flow generator to produce the modified output water stream.

35. The system of claim 32, further comprising a loading zone adjacent to the conversion zone for receiving fish and water for loading into the conversion zone.

36. The system of claim 3532, wherein the at least one water flow generator comprises a water concentrator to create a water jet, the at least one water concentrator positioned in line with the pump suction inlet to create a cross-flow in the loading zone such that the first fast-moving conversion current passes through the loading zone, the loading zone having a second slower-moving current which is diffuse for creating a path into the conversion zone for the first input water stream.

37. The system of claim 36 wherein the conversion zone is created at an intersection of the first fast-moving conversion current and the loading zone.

38. The system of claim 36 further comprising a fish guidance device configured to direct fish moving through the loading zone to the cross-flow.

39. The system of claim 36 further comprising a water diffuser configured to create a diffuse attraction current within the loading zone.

40. The system of claim 32, wherein the water flow generator is positioned with respect to the pump suction inlet to create a laminar flow.

41. The system of claim 40, wherein the laminar flow comprises:
a first portion of which wraps tightly back to the pump suction inlet creating the second fast-moving conversion current; and
a second portion of which is jetted outwards creating the loading zone having a diffuse attraction current.

42. The system of claim 32, wherein the water flow generator is positioned and constructed such that the water flow generator nozzle is perpendicular to the second input water stream.

43. The system of claim 42, wherein the water flow generator has a curved construction selected from the group consisting of: a J-shape, an L-shape, a C-shape.

44. The system of claim 32, wherein the water flow generator comprises a plurality of deflector fins.

45. The system of claim 44, wherein the water flow generator comprises a water diffuser including plurality of deflector fins positioned to create a set of diffusion chambers.

46. The system of claim 45, wherein the plurality of deflector fins are positioned to create a plurality of rectangular diffusion chambers including:
a first set of top diffuser chambers; and
a second set of bottom diffuser chambers provided below the first set of top diffuser chambers.

47. The system of claim 32, wherein the water flow generator comprises smooth curved surfaces.

48. The system of claim 44, wherein the plurality of deflector fins comprise smooth curved surfaces.

49. The system of claim 32, wherein the pump suction inlet comprises side walls extending past a front edge of the water flow generator.

50. The system of claim 32, further comprising a pump suction outlet provided between the pump suction inlet and the fish pump entrance interface, the pump suction intake configured to safely transition fish into the fish pump suction.

51. The system of claim 50, wherein the pump suction outlet comprises a pump suction concentrator configured to concentrate the first input water stream as it approaches the fish pump entrance.

52. The system of claim 51, wherein the pump suction outlet comprises smooth curved surfaces.

53. The system of claim 32, wherein the water flow generator is positioned above the pump suction inlet to produce the conversion zone below the loading zone.

54. The system of claim 32, wherein the water flow generator is positioned below the pump suction inlet to produce the conversion zone above the loading zone.

55. The system of claim 32, wherein the water flow generator is positioned beside the pump suction inlet to produce the conversion zone beside the loading zone.

56. The system of claim 32, wherein the water flow generator is positioned behind the pump suction inlet to produce the conversion zone below and behind the loading zone.

57. The system of claim 32, wherein:
the water flow generator comprises a first water diffuser and a second water diffuser; and
the pump suction inlet is positioned between the first water diffuser and the second water diffuser to produce the conversion zone in front of the pump suction inlet and to produce the loading zone on both sides of the conversion zone in front of the first and second water diffusers, the loading zone extending beyond the conversion zone at a distance beyond the pump suction inlet.

58. The system of claim 32, further comprising:
a dam located in front of the pump suction inlet and after an upward water inlet grate, to produce the conversion zone in front of a lower portion of the water diffuser and in front of the entire pump suction inlet as well as between the pump suction inlet and the upward water inlet grate, and to produce the loading zone above the conversion zone and above and in front of the second water diffuser in front of the dam, and
at least one water flow generator comprising a first water diffuser positioned above the pump suction inlet
the at least one water flow generator positioned to create an attraction current that flows over and outwards from the dam, creating an attraction zone in front of and above the dam.

59. The system of claim 58, wherein the water flow generator further comprises a second water diffuser positioned proximal to the dam for creating an additional attraction current across the dam.

60. A fish pump loading system comprising:
a fish loading apparatus having a fish loading inlet and a fish outlet;
a water flow generator having a water inlet and a flow generator outlet;
a fish loading flow path communicating with the fish loading inlet and the fish outlet to receive a first input water stream including a combination of fish and water and to transmit the combination of fish and water to a fish pump entrance;
a water modification flow path communicating with the water inlet and the flow generator outlet to receive a second input water stream independent of the first input water stream and to produce a modified output water stream;
the water modification flow path interacting with the fish loading flow path to produce:
a conversion zone having a first fast-moving conversion current drawing into the fish pump entrance to rapidly convert the fish into the fish pump entrance after the fish swim into the conversion zone; and
a loading zone adjacent the conversion zone having a second slower moving current, to draw upstream-swimming fish towards the conversion zone.

61. The system of claim 60, wherein the water flow generator comprises a water concentrator, and the water concentrator comprises:
a water concentrator inlet configured to receive the second input water stream; and
a water concentrator nozzle configured to concentrate the second input water stream at the outlet of the water flow generator to produce the modified output water stream.

62. The system of claim 60, wherein the water flow generator comprises a water diffuser, and the water diffuser comprises:
a water diffuser inlet configured to receive the second input water stream; and
a water diffuser nozzle configured to diffuse the second input water stream at the outlet of the water flow generator to produce the modified output water stream.
